(19) United States
(12) Patent Application Publication
(10) Pub. No.: US 2025/0370597 A1
(43) Pub. Date: Dec. 4, 2025

(54) FUNCTION ACCESSIBILITY

(71) Applicant: Apple Inc., Cupertino, CA (US)

(72) Inventors: Taylor G. CARRIGAN, San Francisco, CA (US); Edward CHAO, Palo Alto, CA (US)

(21) Appl. No.: 19/050,998

(22) Filed: Feb. 11, 2025

Related U.S. Application Data
(60) Provisional application No. 63/655,576, filed on Jun. 3, 2024.

(51) Int. Cl. G06F 3/0484; G04G 9/00; G06F 3/0362; G06F 3/04817; G06F 3/0482

(52) U.S. Cl. CPC G06F 3/0484; G06F 3/0362; G06F 3/04817; G06F 3/0482; G04G 9/007

(57) ABSTRACT

The present disclosure generally relates to accessing and managing various functions of a computer system.

This application claims priority to U.S. Provisional Patent Application No. 63/655,576, filed Jun. 3, 2024, titled “FUNCTION ACCESSIBILITY,” the entire contents of which is hereby incorporated by reference.

### FIELD

The present disclosure relates generally to computer user interfaces, and more specifically to techniques for accessing and managing various functions of a computer system.

### BACKGROUND

Using a singular input mechanism to control diverse functions presents a straightforward and user-friendly technique for instant access to a device's desired functions. Furthermore, allowing a user to customize and redefine the input mechanism enhances personalization, aligning the device with the user's specific usage preferences. Consequently, such personalization leads to expedited access to preferred functionalities, thereby improving overall efficiency.

### BRIEF SUMMARY

Some techniques for accessing and managing various functions of a computer system, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for accessing and managing various functions of a computer system. Such methods and interfaces optionally complement or replace other methods for accessing and managing various functions of a computer system. Such methods and interfaces reduce the cognitive burden on a user and produce a more efficient human-machine interface. For battery-operated computing devices, such methods and interfaces conserve power and increase the time between battery charges. Additionally, such methods and interfaces allow for quick access to relevant functionality and, as a result, reduce the number of unnecessary/redundant inputs needed to access the relevant information. Moreover, such methods and interfaces allow for quick access to emergency related functionality which provides a computer system with enhanced safety features.

In accordance with some embodiments, a method is described. The method is performed at a computer system that is in communication with one or more display generation components and one or more input devices. The method comprises: detecting, via the one or more input devices, an activation event that includes activation of a first input device of the one or more input devices; and in response to detecting the activation event: in accordance with a determination that the activation event ends within a first period of time and the first input device is associated with a first function, wherein the first period of time ends before a first time threshold has elapsed, initiating a process for performing the first function; and in accordance with a determination that the activation event ends within a second period of time, wherein the second period of time starts after the first time threshold has elapsed, and wherein the second period of time is different from the first period of time, displaying, via the display generation component, a user interface for selecting a different function to be associated with the first input device.

In accordance with some embodiments, a non-transitory computer-readable storage medium is described. The non-transitory computer-readable storage medium stores one or more programs configured to be executed by one or more processors of a computer system that is in communication with one or more display generation component and one or more input devices, the one or more programs including instructions for: detecting, via the one or more input devices, an activation event that includes activation of a first input device of the one or more input devices; and in response to detecting the activation event: in accordance with a determination that the activation event ends within a first period of time and the first input device is associated with a first function, wherein the first period of time ends before a first time threshold has elapsed, initiating a process for performing the first function; and in accordance with a determination that the activation event ends within a second period of time, wherein the second period of time starts after the first time threshold has elapsed, and wherein the second period of time is different from the first period of time, displaying, via the display generation component, a user interface for selecting a different function to be associated with the first input device.

In accordance with some embodiments, a transitory computer-readable storage medium is described. The transitory computer-readable storage medium stores one or more programs configured to be executed by one or more processors of a computer system that is in communication with one or more display generation component and one or more input devices, the one or more programs including instructions for: detecting, via the one or more input devices, an activation event that includes activation of a first input device of the one or more input devices; and in response to detecting the activation event: in accordance with a determination that the activation event ends within a first period of time and the first input device is associated with a first function, wherein the first period of time ends before a first time threshold has elapsed, initiating a process for performing the first function; and in accordance with a determination that the activation event ends within a second period of time, wherein the second period of time starts after the first time threshold has elapsed, and wherein the second period of time is different from the first period of time, displaying, via the display generation component, a user interface for selecting a different function to be associated with the first input device.

In accordance with some embodiments, a computer system that is configured to communicate with one or more display generation component and one or more input devices is described. The computer system includes one or more processors and memory storing one or more programs configured to be executed by the one or more processors. The one or more programs including instructions for: detecting, via the one or more input devices, an activation event that includes activation of a first input device of the one or more input devices; and in response to detecting the activation event: in accordance with a determination that the activation event ends within a first period of time and the first input device is associated with a first function, wherein the first period of time ends before a first time threshold has elapsed, initiating a process for performing the first function; and in accordance with a determination that the activation event ends within a second period of time, wherein the second period of time starts after the first time threshold has elapsed, and wherein the second period of time is different from the first period of time, displaying, via the display generation component, a user interface for selecting a different function to be associated with the first input device.

In accordance with some embodiments, a computer system configured to communicate with one or more display generation component and one or more input devices is described. The computer system includes: means for detecting, via the one or more input devices, an activation event that includes activation of a first input device of the one or more input devices; and in response to detecting the activation event: means for, in accordance with a determination that the activation event ends within a first period of time and the first input device is associated with a first function, wherein the first period of time ends before a first time threshold has elapsed, initiating a process for performing the first function; and means for, in accordance with a determination that the activation event ends within a second period of time, wherein the second period of time starts after the first time threshold has elapsed, and wherein the second period of time is different from the first period of time, displaying, via the display generation component, a user interface for selecting a different function to be associated with the first input device.

In accordance with some embodiments, a computer program product is described. The computer program product comprises one or more programs configured to be executed by one or more processors of a computer system that is in communication with one or more display generation component and one or more input devices. The one or more programs including instructions for: detecting, via the one or more input devices, an activation event that includes activation of a first input device of the one or more input devices; and in response to detecting the activation event: in accordance with a determination that the activation event ends within a first period of time and the first input device is associated with a first function, wherein the first period of time ends before a first time threshold has elapsed, initiating a process for performing the first function; and in accordance with a determination that the activation event ends within a second period of time, wherein the second period of time starts after the first time threshold has elapsed, and wherein the second period of time is different from the first period of time, displaying, via the display generation component, a user interface for selecting a different function to be associated with the first input device.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for accessing and managing various functionality of an electronic device, thereby increasing the effectiveness, efficiency, and user satisfaction with such devices. Such methods and interfaces may complement or replace other methods for accessing and managing various functionality of an electronic device.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6T illustrate exemplary user interfaces for accessing and managing various functions of a computer system in accordance with some embodiments.

FIG. 7 is a flow diagram of a method for accessing and managing various functions of a computer system in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for accessing and managing various functions of a computer system. Specifically, there is a need for a computer system to enable access to a multitude of functions through a single input mechanism. Furthermore, there is a demand for a computer system that permits the reconfiguration of the input mechanism to align with various functions, thereby granting users more immediate access to their preferred features. Such techniques can reduce the cognitive burden on a user who accesses various functions of the computer system, thereby enhancing productivity. Further, such techniques can reduce processor and battery power otherwise wasted on redundant user inputs.

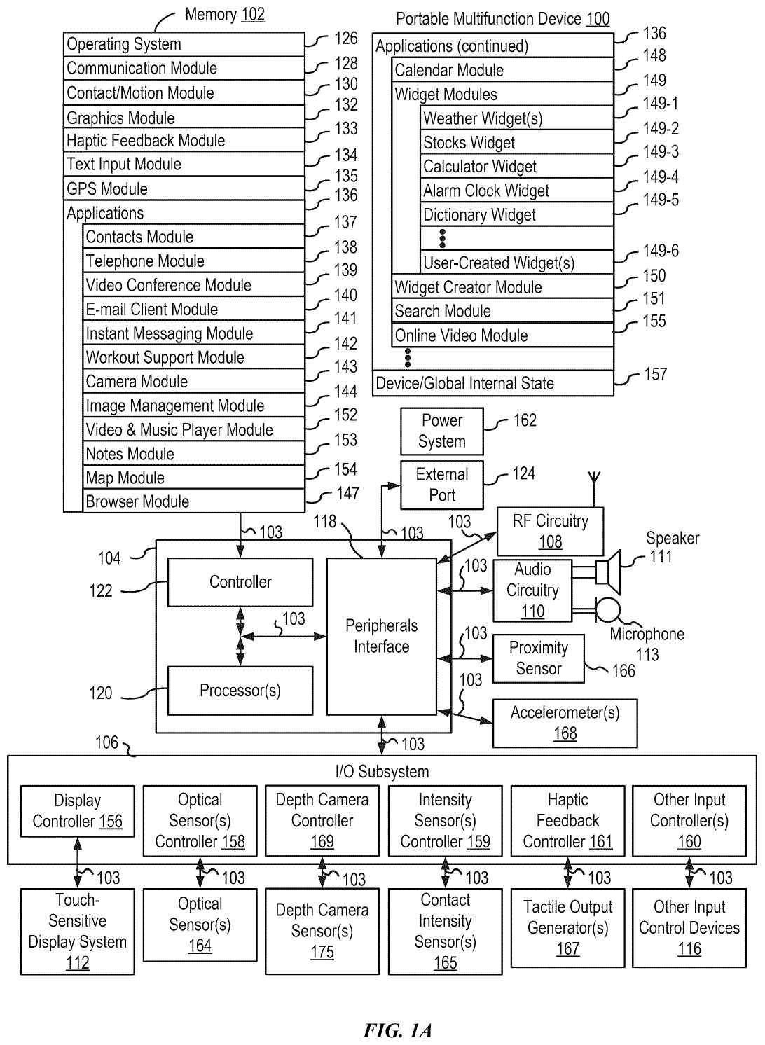

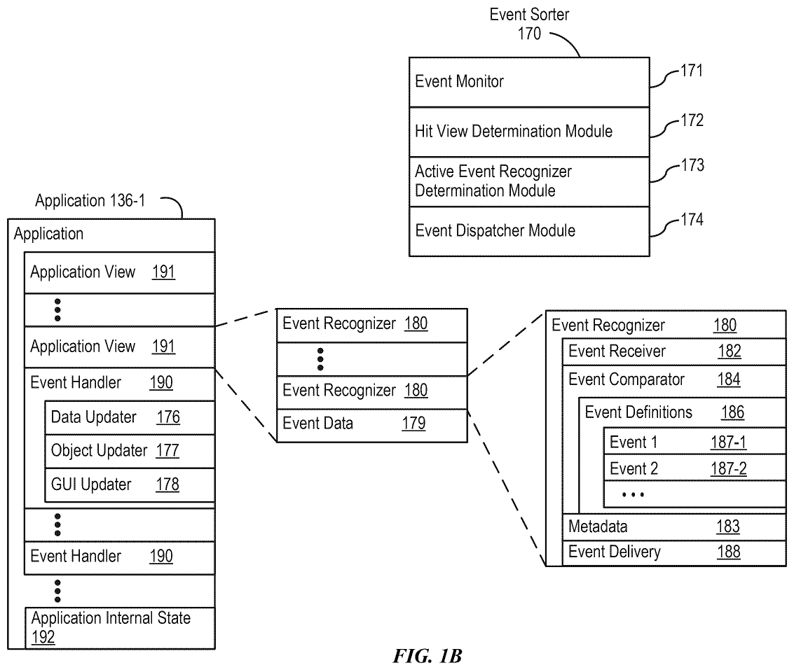

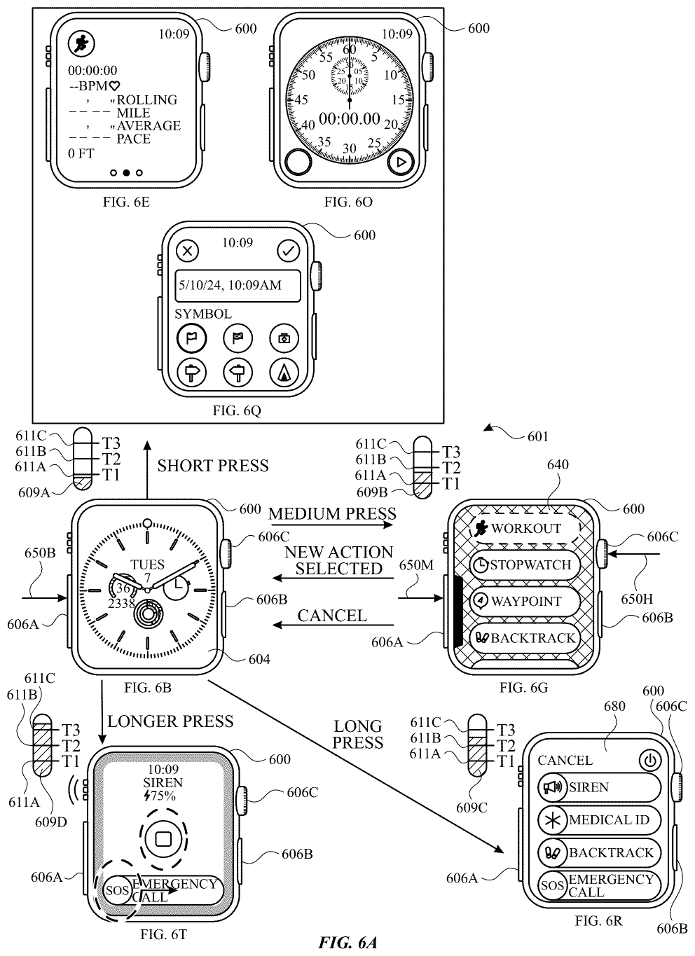

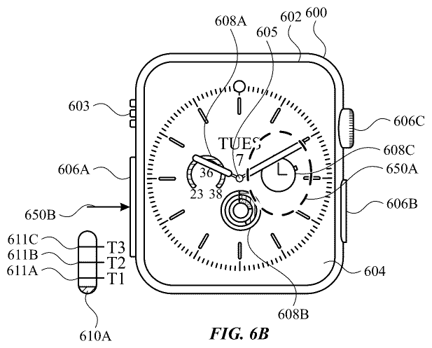

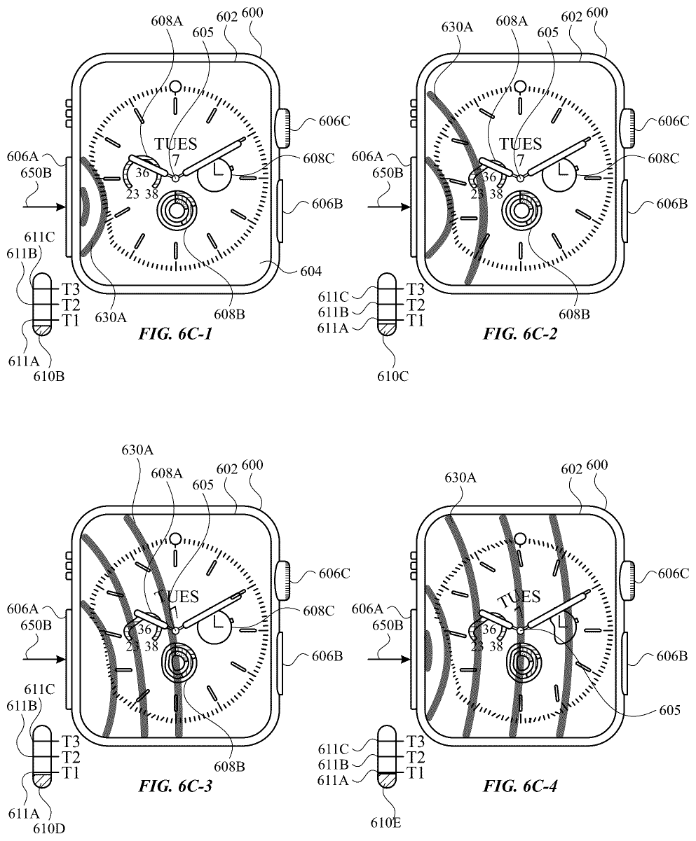

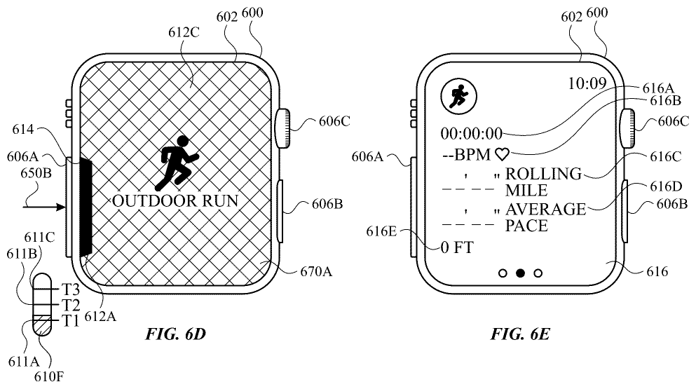

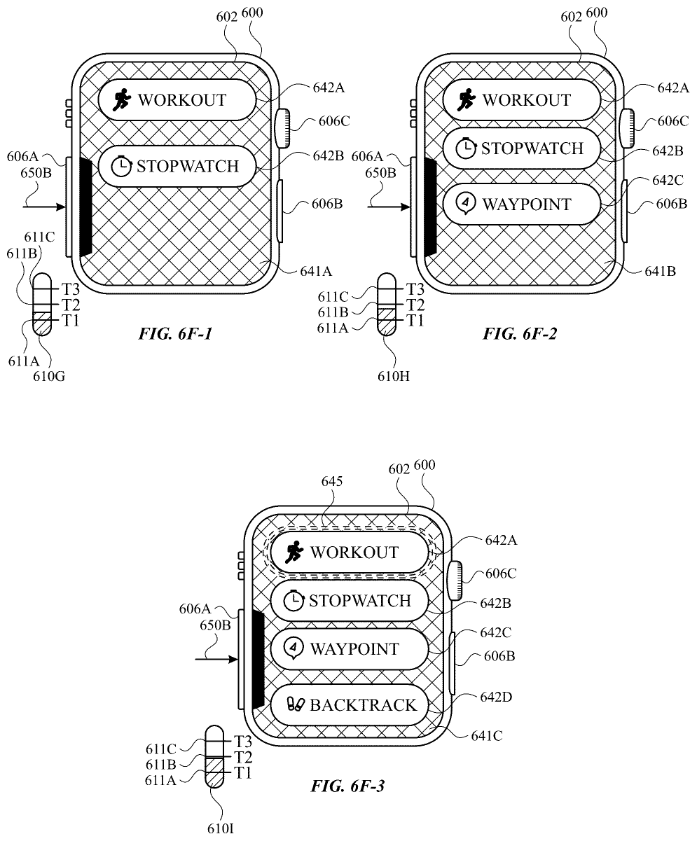

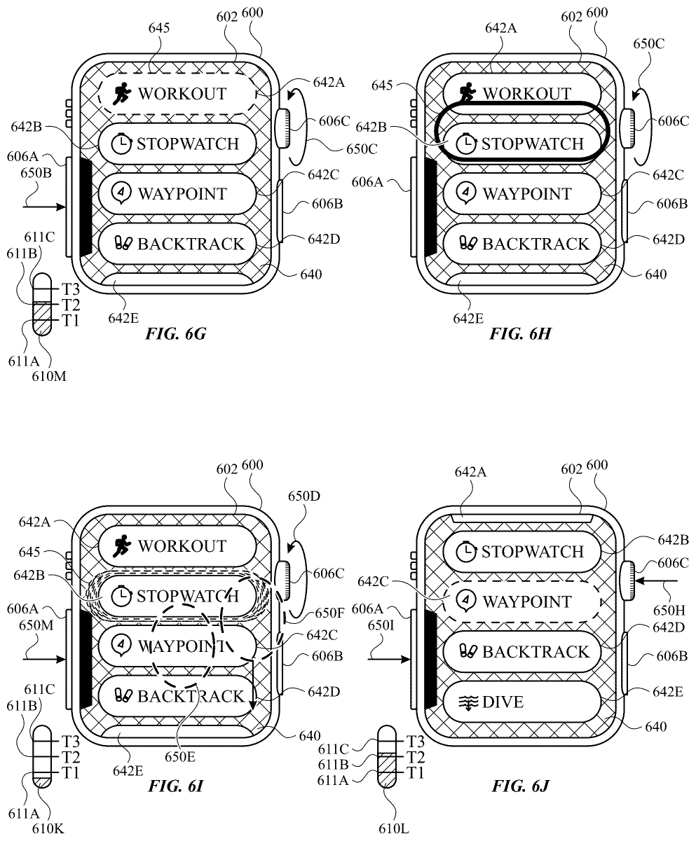

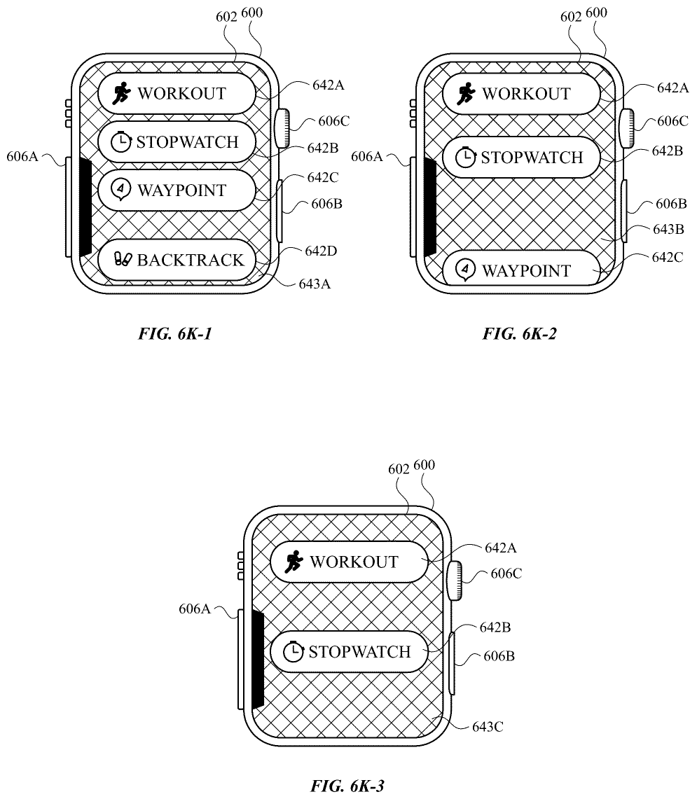

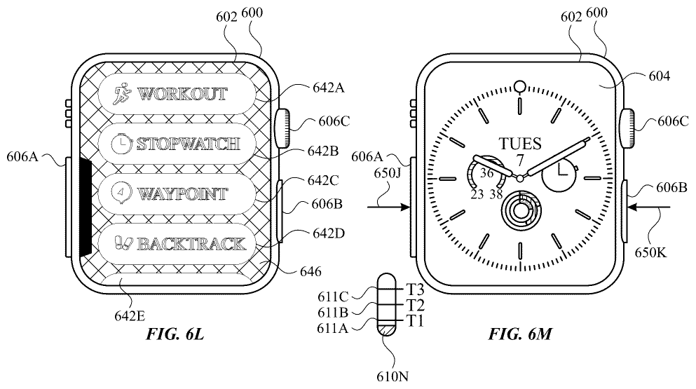

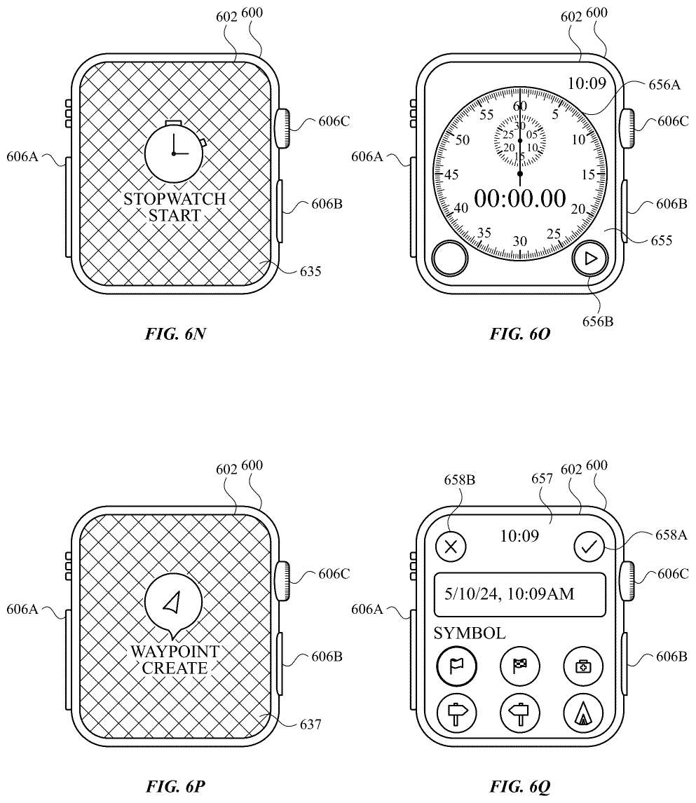

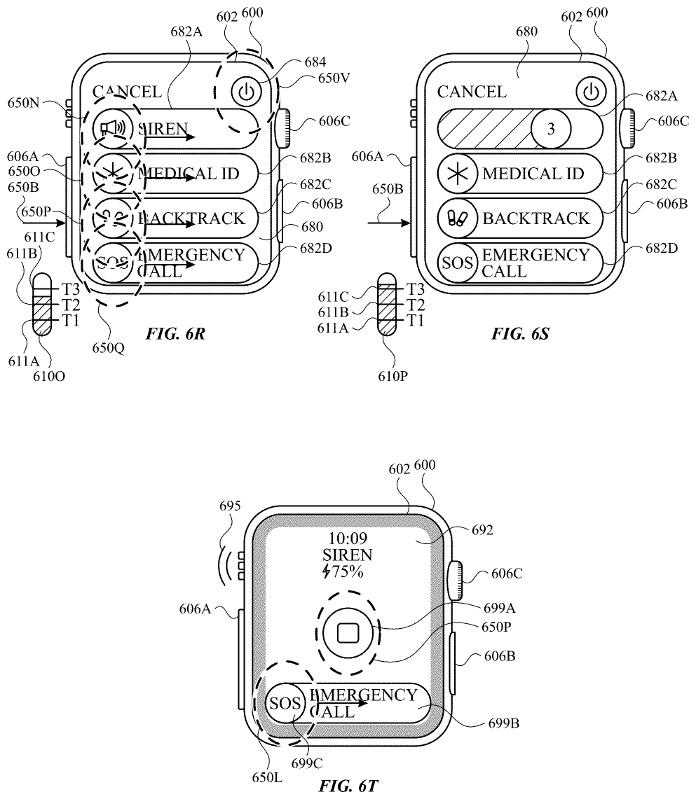

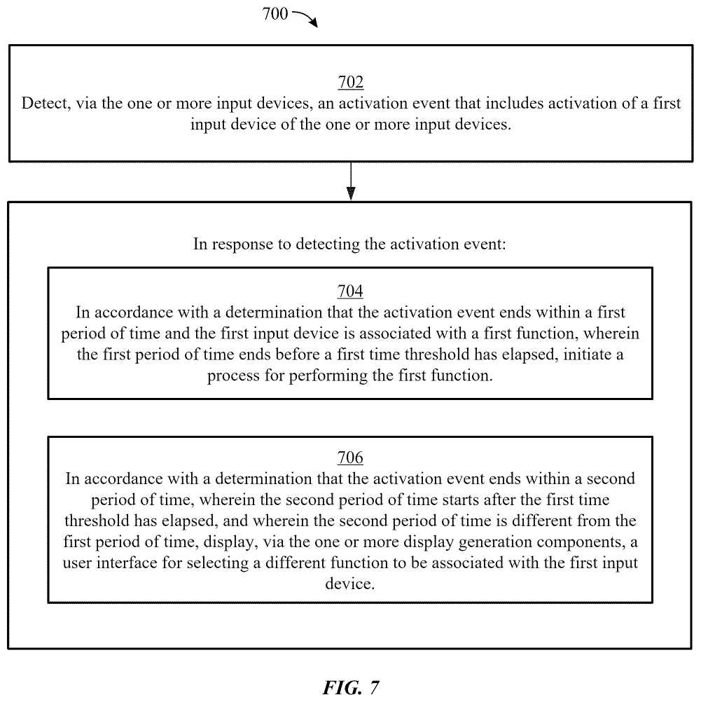

Below, FIGS. 1A-1B, 2, 3A-3G, 4A-4B, and 5A-5B provide a description of exemplary devices for performing the techniques for accessing and managing various functions of a computer system. FIGS. 6A-6T illustrate exemplary user interfaces for accessing and managing various functions of a computer system. FIG. 7 is a flow diagram illustrating methods of accessing and managing various functions of a computer system with some embodiments. The user interfaces in FIGS. 6A-6T are used to illustrate the processes described below, including the processes in FIG. 7.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, providing enhanced safety/security features, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

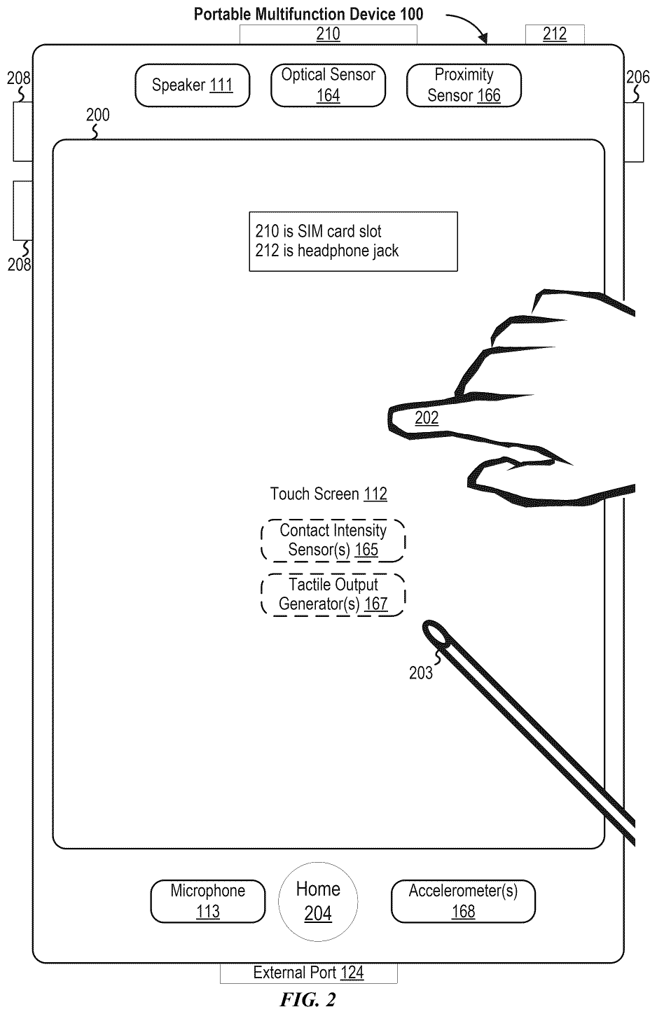

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

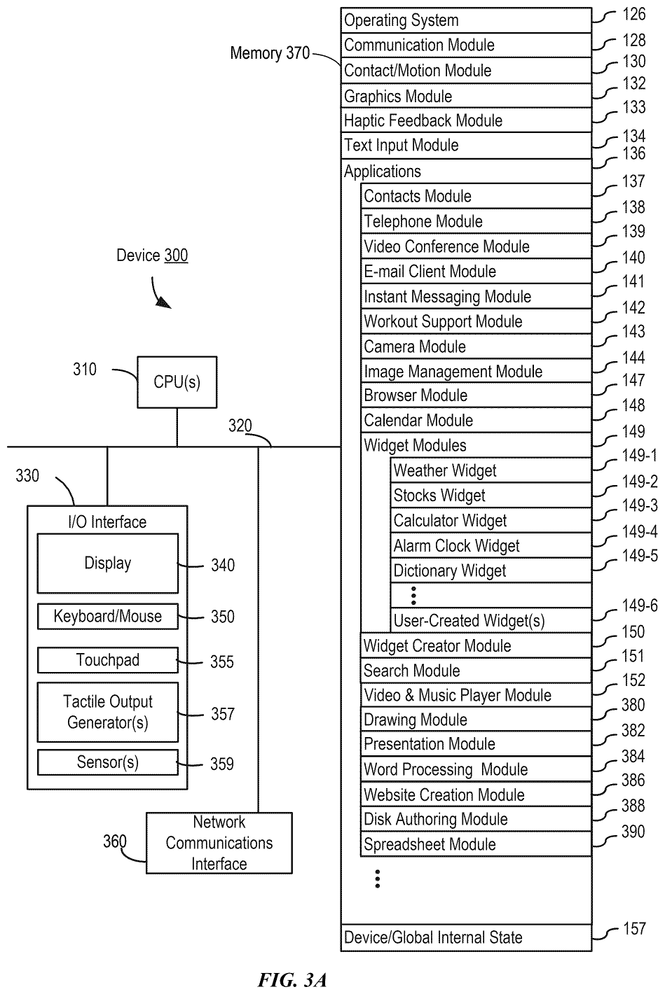

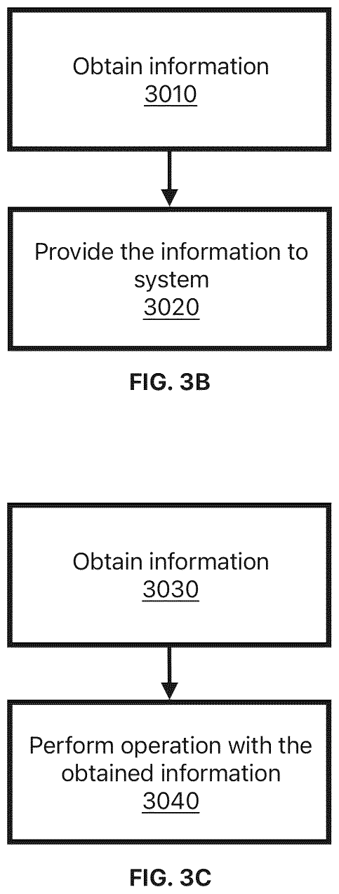

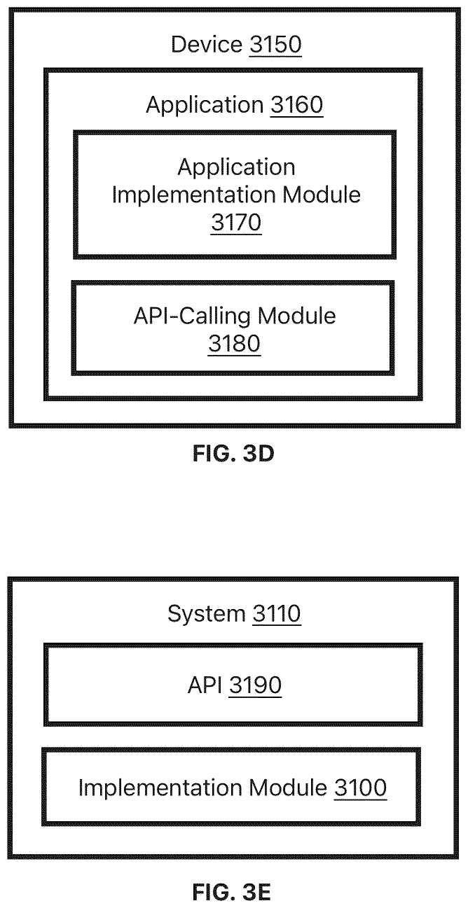

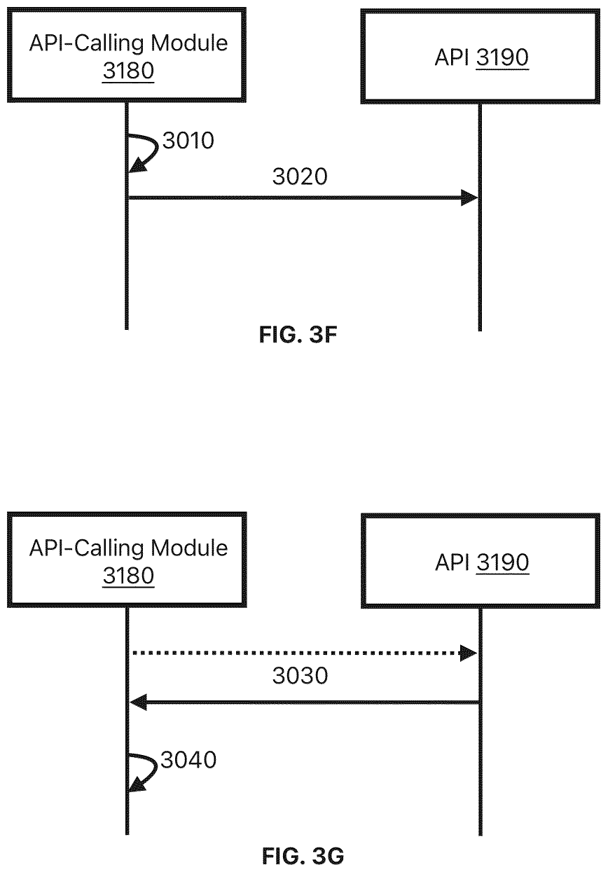

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3D, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

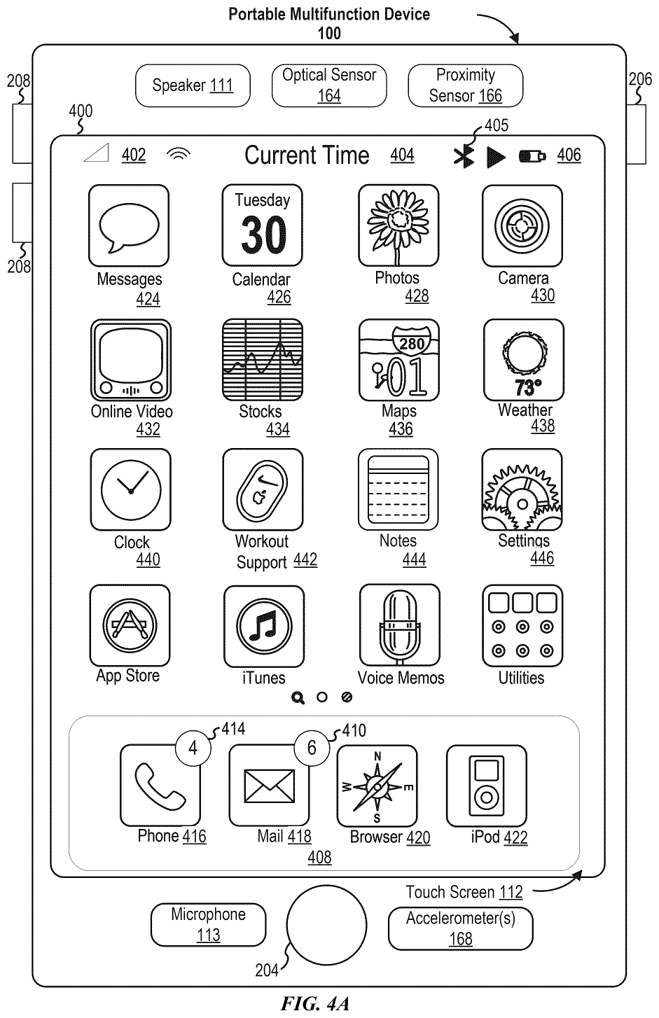

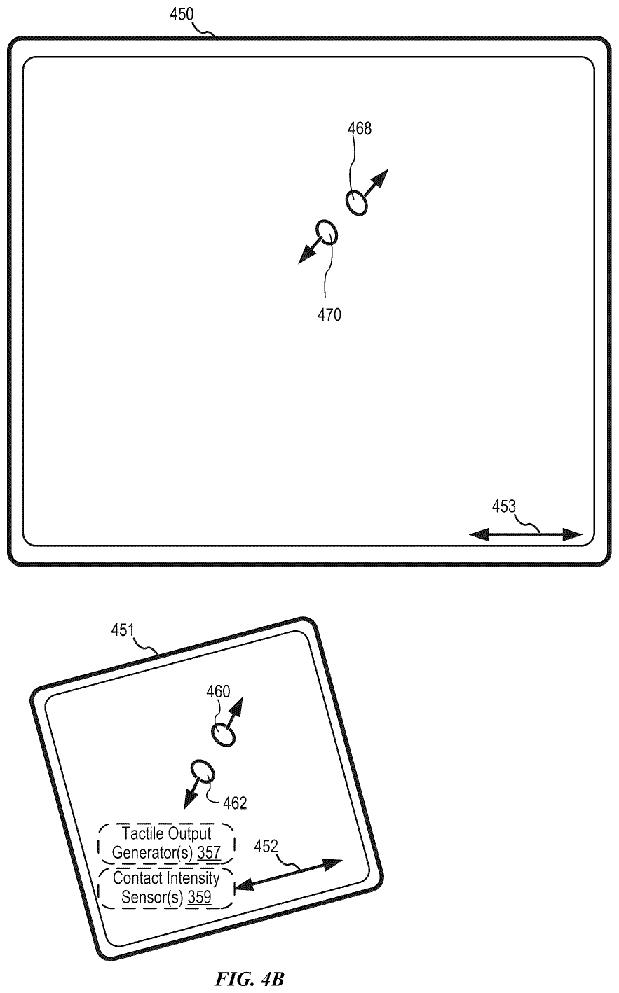

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

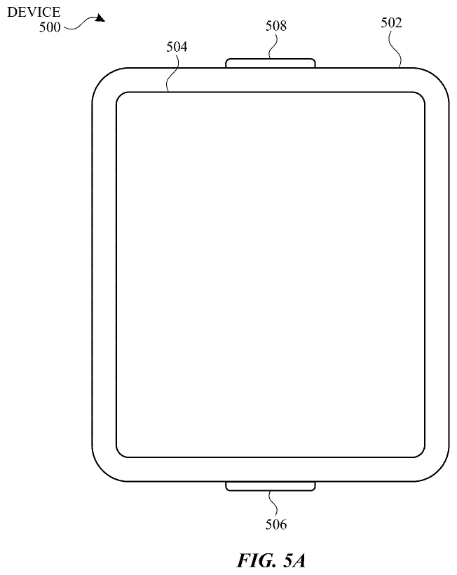

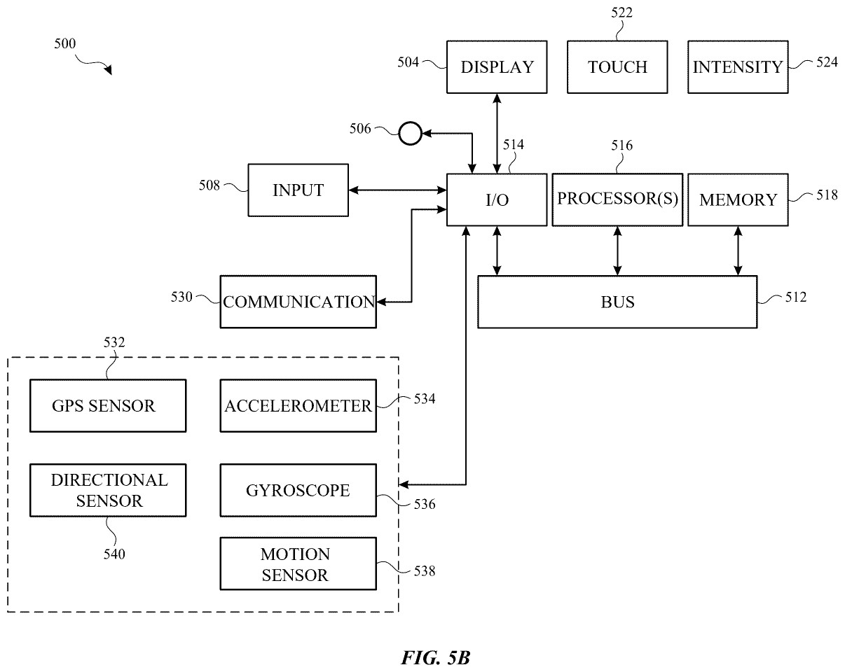

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 (FIG. 7). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

Attention is now directed towards embodiments of user interfaces (“UI”) and associated processes that are implemented on an electronic device, such as portable multifunction device 100, device 300, or device 500.

FIGS. 6A-6T illustrate exemplary user interfaces for accessing and managing various functions of a computer system, in accordance with some embodiments. The user interfaces in these figures are used to illustrate the processes described below, including the processes in FIG. 7.

FIG. 6A illustrates a diagram 601 of various functionalities and interactions of computer system 600. FIG. 6A illustrates computer system 600 that includes first hardware input device 606A, second hardware input device 606B, and third hardware input device 606C. Computer system 600 is configured to perform different functions in response to an input directed to first hardware input device 606A depending on the duration of the input (e.g., a user can use first hardware input device 606A to cause computer system 600 to perform various different functions by pressing first hardware input device 606A for different amounts of time). In some embodiments, first hardware input device 606A is a physical button, a physical depressible button, and/or a solid-state button having a pressure sensor. In some embodiments, first hardware input device 606A includes a tactile output generator that provides tactile feedback (e.g., haptic feedback) in response to detecting input corresponding to first hardware input device 606A. As set forth below, in some embodiments, first hardware input device 606A is user-configurable, such that input corresponding to first hardware input device 606A causes computer system 600 to perform a user-selected function. Second hardware input device 606B includes a button that, when selected, via an input, is configured to cause computer system 600 to perform one or more functions. Third hardware input device 606C includes a rotatable input device that is configured to receive rotational inputs and/or press inputs that cause computer system 600 to perform one or more functions.

FIG. 6A illustrates in diagram 601 that first hardware input device 606A is user-configurable, such that a user of computer system 600 can select and/or otherwise configure first hardware input device 606A to cause computer system 600 to perform a selected function in response to input. While displaying a user interface 604 (e.g., as shown and described with reference to FIG. 6B), computer system 600 detects, via first hardware input device 606A, input 650B and, based on a duration of input 650B (e.g., duration 609A, duration 609B, duration 609C, and duration 609D, referred to as a, “Short Press”, “Medium Press”, “Long Press”, and “Longer Press”, respectively), computer system 600 determines a function to initiate. Duration 609A is shorter than (or in some instances, equal to) first duration threshold 611A, which is shorter than second duration threshold 611B and third duration threshold 611C. Duration 609B is longer than (or in some instances, equal to) first duration threshold 611A, shorter than (or in some instances, equal to) second duration threshold 611B, and shorter than third duration threshold 611C. Duration 609C is longer than first duration threshold 611A, longer than (or in some instances, equal to) second duration threshold 611B, and shorter than and third duration threshold 611C. Duration 609D is longer than first duration threshold 611A, longer than second duration threshold 611B, and longer than (or in some instances, equal to) third duration threshold 611C.

In FIG. 6A, user interface 604 is a watch face user interface. In some embodiments, user interface 604 is a time user interface, a lock screen interface, a wake screen interface, and/or an application interface (e.g., instead of a watch face user interface). In some embodiments, computer system 600 is an electronic device, a smart device (e.g., a smartphone or a smartwatch), a tablet computer, a laptop computer, a desktop computer, a mobile device, a head-mounted device, and/or a wearable device.

In FIG. 6A, in response to detecting that input 650B ends before first duration threshold 611A (e.g., “SHORT PRESS”), computer system 600 initiates a process for displaying a user interface for a selectable function associated with first hardware input device 606A. For example, depending on the function associated with first hardware input device 606A, computer system 600 displays the user interface described in FIG. 6E (e.g., “Outdoor Run”), FIG. 6O (e.g., “Stopwatch”), or FIG. 6Q e.g., “Waypoint”). As a result of computer system 600 detecting input 650B for duration 609A, computer system 600 can quickly initiate the respective function, which enhances the computational efficacy of computer system 600.

In FIG. 6A, in response to detecting that input 650B ends at a time between first duration threshold 611A and second duration threshold 611B (e.g., “MEDIUM PRESS”), computer system 600 initiates a process for displaying function selection interface 640 for changing the selectable function associated with first hardware input device 606A (e.g., as described with reference to FIG. 6G).

While computer system 600 displays function selection interface 640 in FIG. 6A, computer system detects input 650H (e.g., a press input and/or other activation input) (e.g., the “CANCEL” function in FIG. 6A) via third hardware input device 606C. In some embodiments, in response to input 650H via third hardware input device 606C, computer system 600 ceases displaying function selection interface 640 for changing the function associated with first hardware input device 606A and displays (e.g., redisplays) the user interface that was displayed when computer system detected input 650B (e.g., user interface 604) without changing the function associated with first hardware input device 606A. In some embodiments, instead of redisplaying the user interface that was displayed when computer system detected input 650B (e.g., user interface 604), computer system 600 displays a different user interface (e.g., a lock screen, wake screen, or application user interface) irrespective and/or independent of what user interface was displayed when computer system 600 detected input 650B.

While displaying function selection interface 640 in FIG. 6A, computer system detects input 650M on first hardware input device 606A. In some embodiments, in response to detecting input 650M on first hardware input device 606A, computer system 600 changes the function associated with first hardware input device 606A to the function that was in focus in function selection interface 640 when computer system detected input 650M (e.g., “NEW ACTION SELECTED” function in FIG. 6A). In some embodiments, in response to detecting input 650M on first hardware input device 606A, computer system 600 ceases to display function selection interface 640 and redisplays the user interface that was displayed when computer system detected input 650B (e.g., user interface 604). In some embodiments, instead of redisplaying the user interface that was displayed when computer system detected input 650B (e.g., user interface 604), computer system 600 displays a different interface (e.g., a lock screen, wake screen, or application user interface) irrespective and/or independent of what user interface was displayed when computer system detected input 650B.

In FIG. 6A, in response to detecting that input 650B ends at a time between second duration threshold 611B and third duration threshold 611C (e.g., “LONG PRESS”), computer system 600 initiates a process for displaying system function user interface 680 for initiating a system function (e.g., initiating an emergency siren, displaying a medical ID, initiating compass backtrack, and/or initiating an emergency SOS call, as described with reference to FIG. 6R).

In FIG. 6A in response to computer system 600 detecting input 650B for duration 609D (e.g., “Longer Press”), computer system 600 activates (e.g., without additional input) a system function (e.g., outputs an emergency siren, displays a medical ID, activates the compass backtrack, and/or makes an emergency SOS call, as described with reference to FIG. 6T).

The techniques described above with reference to FIG. 6A will now be further described (along with other techniques) with reference to FIGS. 6B-6T. FIG. 6B illustrates computer system 600 with an audio output device 603 displaying, via display device 602, user interface 604. User interface 604 includes user interface objects 608a-608c (e.g., complications, buttons, and/or icons) and time indicator 605 (e.g., an analog and/or digital indication of time). In response to detecting input corresponding to a respective user interface object of user interface objects 608A-608C, computer system 600 displays a user interface of an application that corresponds to the selected user interface object. For instance, at FIG. 6B, computer system 600 detects input 650A (e.g., a tap gesture or other selection input) corresponding to user interface object 608C, which is associated with a stopwatch application of computer system 600. In response to detecting input 650A, computer system 600 displays stopwatch function user interface 655, as shown at FIG. 6O. In some embodiments, user interface 604 is a home and/or default user interface that is displayed by computer system 600 absent input requesting to navigate to a particular application of computer system 600. In some embodiments, instead of user interface 604, computer system 600 displays a lock screen user interface that is either in the locked state or the unlocked state and that includes an indication of time.

At FIG. 6B, computer system 600 detects input 650B (e.g., a single press gesture or other selection input) corresponding to first hardware input device 606A. Computer system 600 detects input 650B for duration 610A. Duration 610A is less than first duration threshold 611A. At FIG. 6B, the first hardware input device 606A is configured to cause computer system 600 to initiate a workout routine, such as an outdoor run, in response to detecting an input on first hardware input device 606A that ends before first duration threshold 611A. As set forth below with reference to FIGS. 6G-6J, a user of computer system 600 can select different functions and/or different types of workout routines that computer system 600 initiates in response to detecting input 650B for a duration that is shorter than (or, in some embodiments, shorter than or equal to) first duration threshold 611A. In some embodiments, the user of computer system 600 can configure first hardware input device 606A via computer system 600 and/or via a companion computer system that is separate from and/or different from computer system 600.

In response to detecting input 650B for a duration less than (or, in some embodiments, equal to) first duration threshold 611A, computer system 600 initiates a process for starting the workout routine, as shown, for example, at FIGS. 6D and 6E. In some embodiments, prior to initiating the process for starting the workout routine, computer system 600 displays an animated transition from user interface 604 to the workout routine function (e.g., as shown in FIGS. 6C-1-6C-4). In some embodiments, computer system 600 does not display (e.g., skips displaying) an animated transition from user interface 604 to the workout routine function (e.g., transitions directly from FIG. 6B to FIG. 6D or FIG. 6E).

At FIG. 6C-1, in response to computer system 600 detecting input 650B (e.g., the input that was initiated in FIG. 6B) for a duration less than (or, in some embodiments, equal to) first duration threshold 611A, computer system 600 initiates a process for transitioning from user interface 604 to function transition interface 670A. In some embodiments, the transition includes distorting, and/or animating user interface 604. For example, at FIG. 6C-1, computer system 600 displays a first state of animated transition 630A. Animated transition 630A begins at the location of first hardware input device 606A. This provides a direct and efficient visual cue, correlating input 650B with animated transition 630A. As animated transition 630A moves across user interface 604, graphical objects displayed on watch user interface 604 become distorted. In FIG. 6C-1, time indicator 605 is distorted, but user interface objects 608A-608C are less distorted (or, optionally, not distorted). In some embodiments, animated transition 630A includes a simulated wave and/or graphical representation that propagates across user interface 604. FIG. 6C-2 displays a second (e.g., subsequent) state of animated transition 630A in which animated transition 630A is further propagated. In some embodiments, animated transition 630A is further propagated in FIG. 6C-2 while computer system 600 continues to detect input 650B for duration 610B (e.g., prior to reaching first duration threshold 611A). In some embodiments, animated transition 630A is further propagated in FIG. 6C-2 after computer system 600 ceases to detect input 650B (e.g., prior to reaching first duration threshold 611A).

At FIG. 6C-2, computer system 600 continues the process for distorting user interface 604 via a second state of animated transition 630A. In FIG. 6C-2, computer system 600 further distorts time indicator 605. Additionally, computer system 600 distorts user interface objects 608A but does not distort user interface objects 608B-608C. In some embodiments, distorting a graphical object includes the graphical object fading out, changing shape, shifting position, and/or changing color to depict the transition to the next user interface (e.g., user interface displayed in FIG. 6D). In some embodiments, computer system 600 displays animated transition 630A at a predetermined speed until the next user interface (e.g., user interface displayed in FIG. 6D) is displayed. Animated transition 630A is further propagated in FIG. 6C-3. In some embodiments, animated transition 630A is further propagated in FIG. 6C-3 while computer system 600 continues to detect input 650B for duration 610C (e.g., prior to reaching first duration threshold 611A). In some embodiments, animated transition 630A is further propagated in FIG. 6C-3 after computer system 600 ceases detecting input 650B (e.g., prior to reaching first duration threshold 611A).

At FIG. 6C-3, computer system 600 continues the process for distorting user interface 604 via a third state of animated transition 630A. In FIG. 6C-3, computer system 600 further distorts time indicator 605. Additionally, computer system 600 distorts user interface objects 608A and 608B but does not distort user interface object 608C (or, optionally, distorts user interface object 608C to a lesser degree). Animated transition 630A is further propagated in FIG. 6C-4. In some embodiments, animated transition 630A is further propagated in FIG. 6C-4 while computer system 600 continues to detect input 650B for duration 610D (e.g., prior to reaching first duration threshold 611A). In some embodiments, animated transition 630A is further propagated in FIG. 6C-4 after computer system 600 ceases detecting input 650B (e.g., prior to reaching first duration threshold 611A).

At FIG. 6C-4, computer system 600 continues the process for distorting user interface 604 via fourth state of animated transition 630A. In FIG. 6C-4, computer system 600 further distorts time indicator 605. Additionally, computer system 600 distorts user interface objects 608A-608C. After completing animated transition 630A, computer system displays function transition interface 670A in FIG. 6D. In some embodiments, function transition interface 670A in FIG. 6D is displayed while computer system 600 continues to detect input 650B for duration 610E (e.g., prior to reaching first duration threshold 611A). In some embodiments, function transition interface 670A in FIG. 6D is displayed after computer system 600 ceases to detect input 650B (e.g., prior to reaching first duration threshold 611A).

At FIG. 6D, computer system 600 displays, via display device 602, function transition interface 670A. In some embodiments, computer system 600 displays function transition interface 670A while continuing to detect input 650B. In some embodiments, computer system 600 displays function transition interface 670A after input 650B ends (e.g., prior to reaching first duration threshold 611A). At FIG. 6D, function transition interface 670A includes a symbol and/or icon associated with the selectable function associated with first hardware input device 606A (e.g., an outdoor run workout routine) and text indicating the function (e.g., “OUTDOOR RUN”). Input indicator 612A provides visual confirmation that input 650B was detected by computer system 600 and that function transition interface 670A is displayed in response to detecting input 650B. For instance, input indicator 612A is displayed at location 614 on display device 602 that is next to, near, close to, and/or proximate to a position of first hardware input device 606A (e.g., with respect to display device 602). Input indicator 612A also includes a size (e.g., a length and/or height) that is approximate to a size (e.g., a length and/or height) of first hardware input device 606A to further provide confirmation that function transition interface 670A is displayed in response to detection of input 650B.

At FIG. 6D, function transition interface 670A includes background 612C, which has a first color (e.g., as indicated by first shading at FIG. 6D) that is associated with the selected function. In some embodiments, the first color is based on an application that is associated with the selected function and/or an application that enables computer system 600 to perform the predetermined function. In some embodiments, the first color is based on a color of first hardware input device 606A (e.g., includes a first shade of a color of first hardware input device 606A). In some embodiments, input indicator 612A includes a second color (e.g., as indicated by second shading at FIG. 6D) that is associated with the selected function and/or associated with first hardware input device 606A (e.g., a color of first hardware input device 606A). In some embodiments, background 612C includes a first shade of a color of first hardware input device 606A and input indicator 612A includes a second (e.g., different) shade of the color of first hardware input device 606A.

At FIG. 6D, computer system 600 displays function transition interface 670A while (e.g., in response to) continuing to detect input 650B. In some embodiments, computer system 600 displays function transition interface 670A after input 650B is no longer detected. For example, in some embodiments, computer system 600 displays function transition interface 670A in accordance with a determination that the duration of input 650B is greater than a predetermined duration (e.g., greater than zero) and less than the first duration threshold 611A. In some embodiments, computer system 600 is configured to display function transition interface 670A for a predetermined period of time (e.g., 0.5 seconds, 1 second, 2 seconds, 3 seconds, or 5 seconds) before transitioning to displaying a user interface associated with the selectable function associated with first hardware input device 606A. For instance, after displaying function transition interface 670A for the predetermined period of time (and, optionally, after detecting an end (e.g., release) of input 650B), computer system 600 displays workout user interface 616, as shown at FIG. 6E.

At FIG. 6E, in response to detecting that input 650B ends before first duration threshold 611A, computer system 600 displays workout user interface 616 that includes user interface objects 616A-616E, which provide information and/or data about an ongoing workout routine (e.g., the outdoor run workout routine initiated in response to detecting input 650B). Accordingly, computer system 600 initiates a workout routine and displays workout user interface 616 after (e.g., in response to) detecting input 650B and/or after optionally displaying function transition interface 670A for the predetermined period of time.

At FIG. 6F-1, computer system 600 displays, via display device 602, function animation user interface 641A. At FIG. 6F-1, computer system 600 displays function animation user interface 641A that includes function graphical object 642A and function graphical object 642B. Function graphical object 642A and function graphical object 642B correspond to functions that can be selected (e.g., in FIG. 6I) to be associated with the first hardware input device 606A. Computer system 600 animates function graphical object 642A and function graphical object 642B moving across function animation user interface 641A from the bottom of display device 602 towards the top of display device 602. In some embodiments, function graphical object 642A and function graphical object 642B move (e.g., transition and/or scroll) from the bottom, left, or right of the display device 602 towards a respective opposite position on display device 602. In some embodiments, computer system 600 displays function animation user interface 641B while continuing to detect input 650B in FIG. 6D (e.g., the input that was initiated in FIG. 6B) for duration 610F (e.g., a time between first duration threshold 611A and second duration threshold 611B). In some embodiments, computer system 600 displays function animation user interface 641B after input 650B ends (e.g., after reaching first duration threshold 611A and prior to reaching second duration threshold 611B).

At FIG. 6F-2, computer system 600 displays, via display device 602, function animation user interface 641B that includes function graphical object 642A, function graphical object 642B, and function graphical object 642C. In some embodiments, computer system 600 displays function animation user interface 641B while continuing to detect input 650B in FIG. 6F-1 (e.g., the input that was initiated in FIG. 6B) for duration 610G (e.g., a time between first duration threshold 611A and second duration threshold 611B). In some embodiments, computer system 600 displays function animation user interface 641B after input 650B ends (e.g., after reaching first duration threshold 611A and prior to reaching second duration threshold 611B).

At FIG. 6F-3, computer system 600 displays, via display device 602, function animation user interface 641C that includes function graphical object 642A, function graphical object 642B, function graphical object 642C, and function graphical object 642D. At FIG. 6F-3, function animation user interface 641C includes focus indicator 645 that indicates the current selectable function associated with first hardware input device 606A. Computer system 600, optionally, displays focus indicator 645 in an animated fashion (e.g., pulsating, highlighted, and/or with varying brightness) to indicate to a user which of the respective functions has been associated with first hardware input device 606A. In some embodiments, focus indicator 645 is displayed statically (e.g., without an animation). In some embodiments, computer system displays focus indicator 645 prior to FIG. 6F-3 (e.g., in the beginning of the transition animation, such as in FIG. 6F-1). In some embodiments, computer system 600 does not display focus indicator 645 during a transition animation (e.g., focus indicator 645 is not displayed from FIG. 6D to FIG. 6G). In some embodiments, transition animation (e.g., 641A-641C) is not displayed. Instead, in some embodiments, in response to computer system 600 continuing to detect input 650B (e.g., the input that was initiated in FIG. 6B) for duration 610F, computer system 600 displays, via display device 602, function selection interface 640 in FIG. 6G. In some embodiments, computer system 600 displays function animation user interface 641C while continuing to detect input 650B in FIG. 6F-2 (e.g., the input that was initiated in FIG. 6B) for duration 610H (e.g., a time between first duration threshold 611A and second duration threshold 611B). In some embodiments, computer system 600 displays function animation user interface 641C after input 650B ends (e.g., after reaching first duration threshold 611A and prior to reaching second duration threshold 611B).

At FIG. 6G, computer system 600 displays, via display device 602, function selection interface 640 that includes function graphical object 642A, function graphical object 642B, function graphical object 642C, function graphical object 642D, function graphical object 642E. In some embodiments, after computer system ceases detecting input 650B while displaying function selection interface 640, computer system can detect additional input(s) to interact with function graphical objects 642A-642E. Each of the respective function graphical objects (e.g., 642A-642E) correspond to different/functions that can be associated with first hardware input device 606A. Function graphical object 642A corresponds to a workout function. Function graphical object 642B corresponds to a stopwatch function. Function graphical object 642C corresponds to an interface for setting a waypoint. Function graphical object 642D corresponds to a backtrack function. FIG. 6G also illustrates computer system 600 displaying focus indicator 645 with an animation (e.g., pulsating, highlighted, and/or varying brightness) to indicate to a user which function is currently associated with first hardware input device 606A. In some embodiments, focus indicator 645 is displayed statically (e.g., without an animation). FIG. 6G further depicts computer system 600 continuing to detect input 650B for duration 610M and detecting rotational input 650C via third hardware input device 606C (e.g., a crown and/or rotatable input mechanism). In some embodiments, computer system 600 displays function selection interface 640 while continuing to detect input 650B in FIG. 6F-3 (e.g., the input that was initiated in FIG. 6B) for duration 610I (e.g., a time between first duration threshold 611A and second duration threshold 611B). In some embodiments, computer system 600 displays function selection interface 640 after input 650B ends (e.g., after reaching first duration threshold 611A and prior to reaching second duration threshold 611B).

At FIG. 6H, while function selection interface 640 is displayed and in response to detecting rotational input 650C, computer system 600 initiates movement of focus indicator 645 from function graphical object 642A to another function graphical object (e.g., 642B-642E). While moving, focus indicator 645 expands in size so that it is larger than the displayed function graphical objects (e.g., 642B-642E). In some embodiments, focus indicator 645 does not expand while moving and is the same size or smaller than the displayed function graphical objects (e.g., 642B-642E). In some embodiments, focus indicator 645 is static or animated while moving from the currently selected function graphical object 642A to another function graphical object (e.g., 642B-642E). In FIG. 6H, computer system 600 continues to detect rotational input 650C for moving the focus indicator 645.

At FIG. 6I, in response to continuing to detect rotational input 650C in FIG. 6H, computer system 600 moves focus indicator 645 to function graphical object 642B. In some embodiments, while focus indicator 645 is displayed over function graphical object 642B (“Stopwatch”), focus indicator 645 is animated (e.g., pulsates, changes size, and/or varies brightness) to draw attention to the currently selected function graphical object 642B. In some embodiments, while focus indicator 645 is displayed over function graphical object 642B (“Stopwatch”), focus indicator 645 is static (e.g., not animated). In some embodiments, in response to continuing to detect rotational input 650C in FIG. 6H, computer system 600 scrolls function graphical objects (e.g., 642B-642E) concurrently with moving focus indicator 645. FIG. 6I also depicts computer system 600 detecting, via the first hardware input device 606A, input 650M for duration 610K, which is shorter than or equal to first duration threshold 611A. As described below in greater detail, in response to detecting input 650M for duration 610K, computer system 600 initiates a process to associate the first hardware input device 606A with the function corresponding to function graphical object 642B (“Stopwatch”). FIG. 6I additionally depicts computer system 600 detecting, via the third hardware input device 606C, rotational input 650D for moving focus indicator 645 to function graphical object 642C. FIG. 6I additionally depicts computer system 600 detecting input 650E (e.g., tap input, air gesture, or mouse click) for placing focus on (e.g., moving focus indicator 645 to) function graphical object 642C. FIG. 6I additionally depicts computer system 600 detecting, input 650F (e.g., swipe input, air gesture, or mouse drag gesture) for scrolling through (and optionally moving focus indicator 645 through) function graphical objects (e.g., 642A-642E).

At FIG. 6J, in response to detecting rotational input 650D in FIG. 6I, computer system 600 moves (e.g., repositions, shifts, and/or scrolls) focus indicator 645 to function graphical object 642C (“Waypoint”). Additionally, in response to detecting rotational input 650D, computer system 600 scrolls (e.g., shifts and/or repositions), function graphical object 642A so that function graphical object 642A is partially off the display device 602 and brings into full view function graphical object 642E (“Dive”). As a result of the scroll, computer system 600 displays function graphical object 642C (“Waypoint”) in a substantially central location on display device 602. In some embodiments, computer system 600 scrolls (e.g., shifts and/or repositions), function graphical object 642A completely off the display device 602. In some embodiments, in response to detecting a rotational input (e.g., 650D), computer system 600 scrolls and/or shifts a plurality of function graphical objects (e.g., 642A-642E) completely or partially off the display device 602 and brings into view (scrolls onto display device 602) a plurality of function graphical objects (e.g., 642A-642E). In some embodiments, in response to detecting rotational input 650D in FIG. 6I, computer system 600 moves (e.g., repositions, shifts, and/or scrolls) focus indicator 645 to function graphical object 642C (“Waypoint”) without scrolling (e.g., shifting and/or repositioning) the displayed function graphical objects (e.g., 642A-642E).

At FIG. 6J, in response to detecting input 650F (e.g., swipe input, air gesture, or mouse drag gesture) in FIG. 6I, computer system 600 moves focus to function graphical object 642C (e.g., computer system 600 repositions, shifts, and/or scrolls focus indicator 645 to a location of function graphical object 642C). Additionally, in response to detecting rotational input 650D, computer system 600 scrolls (e.g., shifts and/or repositions) function graphical object 642A so function graphical object 642A is partially off display device 602 and brings into full view function graphical object 642C (e.g., “Dive”). In some embodiments, in response to detecting input 650F, computer system 600 displays function graphical object 642C (“Waypoint”) in a substantially central location on display device 602. In some embodiments, computer system 600 scrolls (e.g., shifts, and/or repositions) function graphical object 642A completely off the display device 602 (e.g., removes and/or ceases display of function graphical object 642A). In some embodiments, in response to computer system 600 detecting input 650F computer system 600 moves (e.g., repositions, shifts, and/or scrolls), a plurality of function graphical objects (e.g., 642A-E) completely or partially off the display device 602 and brings into view (scrolls onto display device 602) a plurality of function graphical objects (e.g., 642A-642E). In some embodiments, in response to detecting input 650F in FIG. 6I, computer system 600 moves (e.g., repositions, shifts, and/or scrolls) focus indicator 645 to function graphical object 642C (“Waypoint”) without scrolling (e.g., shifting and/or repositioning) the displayed function graphical objects (e.g., 642A-E).

At FIG. 6J, in response to detecting input 650E (e.g., tap input, air gesture, or mouse click) in FIG. 6I, computer system 600 moves (e.g., repositions, shifts, and/or scrolls) focus indicator 645 to function graphical object 642C (“Waypoint”). Additionally, in response to detecting input 650E, computer system 600 scrolls (e.g., shifts and/or repositions), function graphical object 642A so that function graphical object 642A is partially off the display device 602 and brings into full view function graphical object 642C. As a result, of the scroll, computer system 600 displays function graphical object 642C in a substantially central location on display device 602. In some embodiments, computer system 600 scrolls (e.g., shifts and/or repositions), function graphical object 642A completely off the display device 602. In some embodiments, in response to detecting input (e.g., 650E), computer system 600 moves (e.g., repositions, shifts, and/or scrolls) a plurality of function graphical objects completely or partially off display device 602 and brings into view (e.g., scrolls onto display device 602) a plurality of different function graphical objects.

In some embodiments, in response to detecting input 650E in FIG. 6I, computer system 600 moves (e.g., repositions, shifts, and/or scrolls) focus indicator 645 to function graphical object 642C without scrolling the displayed function graphical objects (e.g., 642A-642E). In some embodiments, in response to detecting input 650E (e.g., tap input, air gesture, or mouse click) in FIG. 6I, computer system 600 associates with the first hardware input device 606A a function corresponding to function graphical object 642C, ceases display of function selection interface 640, and displays user interface 604 in FIG. 6M. FIG. 6J additionally depicts computer system 600 detecting input 650H (e.g., press of the rotatable input mechanism and/or touch of the rotatable input mechanism) for canceling the option to change the configuration of first hardware input device 606A. In some embodiments, in response to computer system 600 detecting, via the first hardware input device 606A, input 650I for duration that is shorter than or equal to first duration threshold 611A, computer system 600 initiates a process to associate the first hardware input device 606A with the function corresponding to function graphical object 642C.

At FIG. 6K-1, in response to computer system 600 detecting input 650H in FIG. 6J (e.g., press of the rotatable input mechanism and/or touch of the rotatable input mechanism), computer system 600 displays, via display device 602, a transition animation for canceling the option to change the configuration of first hardware input device 606A. At FIG. 6K-1, computer system 600 displays function cancel animation user interface 643A that depicts function graphical object 642A, function graphical object 642B, function graphical object 642C, and function graphical object 642D moving (e.g., repositioning, shifting, and/or scrolling) on display device 602. As a result of the movement, function graphical object 642E is no longer displayed on display device 602 and has been scrolled off display device 602 (e.g., scrolled off the bottom, top, and/or side of display device 602). In some embodiments, in response to computer system 600 detecting input 650H in FIG. 6J (e.g., press of the rotatable input mechanism and/or touch of the rotatable input mechanism), computer system 600 displays, via display device 602, user interface 604 in FIG. 6M (e.g., does not display a transition animation for canceling the option to change the configuration of first hardware input device 606A).

At FIG. 6K-2, computer system 600 displays, via display device 602, a continuation of the transition animation that started in FIG. 6K-1. At FIG. 6K-2, computer system 600 displays function cancel animation user interface 643B that depicts function graphical object 642A, function graphical object 642B, and function graphical object 642C continuing to move (e.g., repositioning, shifting, and/or scrolling) on display device 602. As a result of the movement, function graphical object 642D is no longer displayed on display device 602 and has been scrolled off display device 602 (e.g., scrolled off the bottom, top, and/or side of display device 602).

At FIG. 6K-3, computer system 600 optionally displays, via display device 602, a continuation of the transition animation that started in FIG. 6K-1 and continued in FIG. 6K-2. At FIG. 6K-3, computer system 600 displays function cancel animation user interface 643C that depicts function graphical object 642A and function graphical object 642B continuing to move (e.g., repositioning, shifting, and/or scrolling) on display device 602. As a result of the movement, function graphical object 642C is no longer displayed on display device 602 and has been scrolled off (e.g., from the bottom, top, side) display device 602. In some embodiments, during the transition animation (e.g., FIG. 6K-1-FIG. 6K-3) computer system moves the lowest displayed function graphical object off the display one at a time so that the remaining (e.g., non-lowest) function graphical objects (e.g., 642A-642E) remain stationary until they are the lowest displayed function graphical object. In some embodiments, during the transition animation (e.g., FIG. 6K-1-FIG. 6K-3) computer system moves each of the displayed respective function graphical object at different rates off the display so that the space between the respective function graphical objects (e.g., 642A-642E) varies (e.g., is not constant) as they are transitioned off the display device 602 (e.g., the space between 642A and 642B increases as 642B approaches the bottom of display device 602).

At FIG. 6L, in response to computer system 600 detecting input 650M in FIG. 6I for duration 610K, which is shorter than (or, in some instances, equal to) first duration threshold 611A, computer system 600 associates first hardware input device 606A with the function corresponding to function graphical object 642B (e.g., “Stopwatch”) and computer system 600 displays confirmation transition interface 646 for associating the first hardware input device 606A with the function corresponding to function graphical object 642B. At FIG. 6L, computer system 600 depicts function graphical object 642A, function graphical object 642B, function graphical object 642C, function graphical object 642D, and function graphical object 642E fading. In some embodiments, instead of (or in some instance, in addition to) fading, computer system 600 displays a different animation. In some embodiments, computer system 600 associates first hardware input device 606A with the function corresponding to function graphical object 642B (“Stopwatch”) without displaying confirmation transition interface 646 in response to computer system 600 detecting input 650M in FIG. 6I.

At FIG. 6M, in response to computer system 600 detecting input 650M in FIG. 6I for duration 610K, which is shorter than first duration threshold 611A, computer system 600 ceases to display function selection interface 640 for changing the selected function associated with first hardware input device 606A, displays confirmation transition interface 646 in FIG. 6L, associates the first hardware input device 606A with the function corresponding to function graphical object 642B (e.g., “Stopwatch”), and displays (e.g., redisplays) user interface 604 (e.g., the same interface as displayed in FIG. 6B). FIG. 6M further depicts computer system 600 detecting, via first hardware input device 606A, input 650J for duration 610N, which is shorter than first duration threshold 611A, to initiate a respective function associated with first hardware input device 606A (e.g., as shown in FIG. 6O or 6Q). FIG. 6M further depicts computer system 600 detecting, via second hardware input device 606B, input 650K, to initiate a process for activating a system function (e.g., as shown in FIGS. 6R-6T).

In response to computer system 600 detecting input 650J in FIG. 6M, computer system 600 performs the function currently associated with first hardware input device 606A. For example, if function graphical object 642B was selected in FIG. 6I, computer system 600 initiates a process for starting the stopwatch function corresponding to function graphical object 642B as shown at FIG. 6O. In some embodiments, prior to initiating the process for starting the stopwatch function, computer system 600 displays animated transition 635 in FIG. 6N from user interface 604 to stopwatch function user interface 655 as shown at FIG. 6O. Animated transition 635 from user interface 604 to stopwatch function user interface 655 is similar (e.g., in behavior and/or appearance) to animated transition 630A, as described above.

At FIG. 6O, stopwatch function user interface 655 includes user interface objects 656A and 656B that allow for interaction with the stopwatch functionality of the stopwatch function user interface 655.

In some embodiments, in response to computer system 600 detecting input 650J in FIG. 6M, computer system 600 performs the function currently associated with first hardware input device 606A. For example, if function graphical object 642C was selected in FIG. 6I, computer system 600 initiates a process for starting the waypoint function corresponding to function graphical object 642C, as shown at FIG. 6Q). In some embodiments, prior initiating the process for starting the waypoint function, computer system 600 displays animated transition 637 in FIG. 6P from user interface 604 to waypoint function user interface 657 as shown at FIG. 6Q. Animated transition 637 from user interface 604 to waypoint function user interface 657 is similar to animated transition 630A, as described above.

At FIG. 6Q, computer system 600 displays waypoint function user interface 657 that includes user interface objects 658A-658B for interaction with the waypoint functionality of the waypoint function user interface 657. In some embodiments, in response to computer system 600 detecting an input corresponding to user interface object 658A, computer system 600 sets a waypoint corresponding to the current location of the user (e.g., the computer system marks a current physical or geographic location of the computer system as a location of interest and saves the location as a waypoint that can be selected by one or more user inputs to initiate a process to provide guidance and/or directions back to the waypoint). In some embodiments, in response to computer system 600 detecting an input corresponding to user interface object 658B, computer system 600 cancels setting a waypoint. In some embodiments, in response to computer system 600 detecting an input corresponding to user interface object 658A, computer system 600 ceases displaying waypoint function user interface 657 and displays user interface 604 as shown in FIG. 6M or FIG. 6B.

At FIG. 6R, in response to computer system 600 continuing to detect input 650B in FIG. 6G (e.g., the input that was initiated in FIG. 6B) for duration 610M, which is longer than second duration threshold 611B, but shorter than third duration threshold 611C, computer system 600 displays system function user interface 680. In some embodiments, after computer system ceases detecting input 650B while displaying system function user interface 680, computer system can detect additional input(s) (e.g., 650N-650Q) to interact with emergency user interface objects 682A-682D for initiating a system function (e.g., initiating an emergency siren, displaying a medical ID, initiating compass backtrack, and/or initiating an emergency SOS call). In some embodiments, while displaying function selection interface 640 and in response to computer system 600 detecting input 650I in FIG. 6J for duration 610L, which is longer than second duration threshold 611B, but shorter than third duration threshold 611C, computer system 600 displays system function user interface 680. In some embodiments, the threshold duration necessary to display system function user interface 680 while displaying function selection interface 640 is different from (e.g., longer or shorter) the duration necessary to display system function user interface 680 while displaying interface 604 (or another interface other than function selection interface 640). For example, in some embodiments, the respective values of T1, T2, and T3 are variable and/or change based on the interface that is displayed at the time computer system 600 detects an input via first hardware input device 606A. In some embodiments, computer system 600 displays system function user interface 680 in response to detecting, via second hardware input device 606B, input 650K in FIG. 6M. System function user interface 680 includes emergency user interface objects 682A-682D and graphical object 684. Emergency user interface objects 682A-682D are configured to, when selected and/or otherwise interacted with, cause computer system 600 to perform respective system functions, such as display medical identification information of a user, initiate an emergency siren, initiate the backtrack function, and/or initiate an emergency phone call. In response to detecting input 650N (e.g., tap, swipe, click, air gesture, or drag) corresponding to emergency user interface object 682A, computer system 600 activates the “Siren” function associated with emergency user interface objects 682A. In response to detecting input 650O (e.g., tap, swipe, click, air gesture, or drag) corresponding to emergency user interface object 682B, computer system 600 activates the “Medical ID” function associated with emergency user interface objects 682B. In response to detecting input 650P (e.g., tap, swipe, click, air gesture, or drag) corresponding to emergency user interface object 682C, computer system 600 activates the “Backtrack” function associated with emergency user interface objects 682C. In response to detecting input 650Q (e.g., tap, swipe, click, air gesture, or drag) corresponding to emergency user interface object 682D, computer system 600 activates the “Emergency Call” function associated with emergency user interface objects 682D. In response to detecting input 650V (e.g., tap, swipe, click, air gesture, or drag) corresponding to graphical object 684, computer system 600 initiates a process for powering off (e.g., changing the power state and/or locking) computer system 600.

At FIG. 6S, in response to computer system 600 continuing to detect input 650B in FIG. 6R (e.g., the input that was initiated in FIG. 6B) for duration 610O, which is longer than second duration threshold 611B and shorter than third duration threshold 611C, computer system 600 initiates (e.g., without additional input(s)) a process for activating a system function (e.g., “Siren”) corresponding to emergency user interface object 682A. In some embodiments, computer system 600 initiates (e.g., without additional input(s)) the process for activating a system function (e.g., “Siren”) corresponding to emergency user interface object 682A in response to continuing to detect, via second hardware input device 606B, input 650K which was initiated in FIG. 6M. In response to continuing to detect input 650B while system function user interface 680 is displayed, computer system 600 displays countdown user interface object 690 on emergency user interface object 682A. Countdown user interface object 690 provides a visual indication of a duration for maintaining input 650B that causes computer system 600 to perform the emergency function. In some embodiments, in response to continuing to detect input 650B while displaying system function user interface 680, computer system 600 is configured to begin outputting audio while displaying countdown user interface object 690. In some embodiments, when computer system 600 outputs audio while displaying countdown user interface object 690, computer system 600 gradually increases a volume level of the audio as countdown user interface object 690 expires, progresses, and/or elapses.

At FIG. 6T, in response to computer system 600 continuing to detect input 650B in FIG. 6S (e.g., the input that was initiated in FIG. 6B) for duration 610P, which is longer than (or in some instances, equal to) third duration threshold 611C, computer system 600 initiates (e.g., without additional input(s)) the emergency siren function. In some embodiments, in response to detecting the end of input 650B before the period of time corresponding to countdown user interface object 690 has elapsed, computer system 600 does not perform the emergency siren (e.g., forgoes output of audio 695) and displays system function user interface 680, as shown at FIG. 6R. In some embodiments, in response to computer system ceasing to detect input 650B at a time after third duration threshold 611C, computer system 600 initiates (e.g., without additional input(s)) the emergency siren function.

Initiation of the emergency siren function includes computer system 600 displaying emergency siren user interface 692 and outputting audio 695 corresponding to the emergency siren. Audio 695 includes a volume that is above the threshold volume level (e.g., above 60 decibels, above 70 decibels, above 80 decibels, and/or above 85 decibels) to allow a user to request assistance in an emergency situation and provide a way for the computer system (and the associated user) to be located by another person or device that is within audio range of the emergency siren. In some embodiments, audio 695 is output at a waveform (e.g., volume, frequency, wavelength, tone, and/or pitch) that enables audio 695 to be heard by other people or devices located at least a threshold distance from computer system (e.g., more than 100 feet, more than 200 feet, more than 300 feet, and/or more than 400 feet) in an expected range of operating conditions. In some embodiments, computer system 600 outputs audio 695 continuously. In some embodiments, computer system 600 outputs audio 695 as audio bursts that occur at intervals of time (e.g., uniform intervals of time and/or dynamic intervals of time that change based on a context of computer system 600 (e.g., a battery charge of computer system 600)). In some embodiments, computer system 600 outputs audio 695 at a volume level, frequency, pitch, and/or tone that is selected to maximize a distance from computer system 600 at which audio 695 is configured to be heard, while minimizing battery usage of computer system 600 (e.g., computer system 600 selects audio properties of audio 695 by determining a maximum distance from computer system 600 that minimizes battery usage of computer system 600).

At FIG. 6T, emergency siren user interface 692 includes stop user interface object 699A, and emergency phone call user interface object 699B. In response to detecting input 610P on stop user interface object 699A, computer system 600 causes performance of the emergency siren function to stop and/or pause. In some embodiments, in response to detecting input (e.g., 650K) corresponding to stop user interface object 699A, computer system 600 ceases to output audio 695 and displays system function user interface 680, as shown at FIG. 6R. Further, emergency phone call user interface object 699B is configured to, when selected (e.g., via input 650L) and/or otherwise interacted with, cause computer system 600 to initiate an emergency phone call. In some embodiments, computer system 600 pauses output of audio 695 in response to initiation of the emergency phone call and resumes (e.g., automatically without additional input) output of audio 695 in response to the emergency phone call ending. In some embodiments, the emergency phone call is initiated by computer system 600 as an outgoing phone call to a phone number associated with an emergency service (e.g., 911, a local emergency service center, and/or a hospital). In some embodiments, computer system 600 initiates the emergency phone call in response to detecting a swipe and/or slide gesture on portion 699C of emergency phone call user interface object 699B. In some embodiments, while displaying emergency siren user interface 692, computer system 600 detects an input (e.g., a press gesture or other selection/navigation input) corresponding to second hardware input device 606B and, in response to detecting the input corresponding to second hardware input device 606B, computer system 600 displays user interface 604, as shown at FIG. 6B or FIG. 6M.

FIG. 7 is a flow diagram illustrating a method for 700 using a computer system in accordance with some embodiments. Method 700 is performed at a computer system (e.g., 100, 300, 500, and/or 600) (e.g., an electronic device; a smart device, such as a smartphone or a smartwatch; a tablet computer; a laptop computer; a desktop computer; a mobile device; a head-mounted device; and/or a wearable device) that is in communication with one or more display generation components (e.g., 602) (e.g., a display controller, a touch-sensitive display system, a projector, a display screen, a display monitor, a head mounted display, and/or a holographic display) and one or more input devices (e.g., 606A-606C). In some embodiments, the one or more input devices includes one or more hardware input devices (e.g., 606A-606C); one or more physical buttons (e.g., 606A and 606B), such as buttons included in and/or on a housing of the computer system; one or more rotatable input devices (e.g., 606C); one or more depressible input devices (e.g., 606A-606C), and/or solid-state buttons having a pressure sensor that are configured to cause the computer system to perform a function in response to an activation event (e.g., a user input, a user-defined and/or user-selected user input, and/or a particular input.) In some embodiments, the one or more input devices includes a hardware input device (e.g., a depressible hardware button) that is configurable (e.g., user selected, user defined, and/or user customized) so that the computer system performs a predefined function in response to a user input (e.g., a predefined input of a particular type). In some embodiments, the one or more input devices include a tactile output generator that provides tactile feedback (e.g., haptic feedback) in response to detecting user input corresponding to a respective hardware input device of the one or more input devices. In some embodiments, a solid-state button is physically differentiated from portions of the computer system that are near the solid-state button (e.g., an indentation, a protrusion, and/or a region with a different texture than nearby portions of the computer system or computer system housing). Some operations in method 700 are, optionally, combined, the orders of some operations are, optionally, changed, and some operations are, optionally, omitted.

As described below, method 700 provides an intuitive way for accessing and managing various functionality of a computer system (e.g., 600). The method reduces the cognitive burden on a user for managing and accessing desired functions, thereby creating a more efficient human-machine interface. For battery-operated computing devices, enabling a user to access and manage various functions faster and more efficiently conserves power and increases the time between battery charges. The computer system (e.g., 600) detects (702), via the one or more input devices (e.g., 606A-606C), an activation event (e.g., 650B) that includes activation of a first input device (e.g., 606A) of the one or more input devices (e.g., 606A-606C) (e.g., a press of a button, activation of a button, and/or deactivation of a button). In some embodiments, the activation event includes a beginning (e.g., an activation of a button, such as a press of a button) and an end (e.g., deactivation of the button, such as release of the button). In response to detecting the activation event (e.g., 650B) and in accordance with a determination that the activation event (e.g., 650B) ends within a first period of time (e.g., a time between zero and 611A) and the first input device (e.g., 606A) is associated with a first function (e.g., a function corresponding to one of 642A-642E), wherein the first period of time (e.g., a time between zero and 611A) ends before (e.g., or, in some instances, at the same time as when) a first time threshold (e.g., 611A) has elapsed (e.g., the activation event ends prior to a first time threshold and/or a duration of the activation event, such as from a beginning of the activation event to an end of the activation event, is less than (or, in some embodiments, is less than or equal to) a first threshold amount of time, such as 0.0001, 0.001, 0.01, 0.1, 0.5, 1, 3, 5, or 10 seconds), the computer system (e.g., 600) initiates (704) a process for performing the first function (e.g., function corresponding to one of 642A-642E, user interface displayed in FIG. 6E, 6O, or 6Q) (e.g., the computer system performs the first function and/or displays one or more selectable user interface elements for initiating the first function). In some embodiments, the computer system initiates the process for performing the first function without displaying a user interface for selecting a different function to be associated with the first input device. In some embodiments, the first function includes adding a new waypoint (e.g., 657 in FIG. 6Q) (e.g., a location that includes a latitude, longitude, and/or elevation) to a location tracking and/or compass application). In some embodiments, the first function includes initiating a shortcut operation of the computer system (e.g., performing one or more predefined and/or user selected operations that are associated with a voice assistant application and/or a shortcut application of the computer system). In some embodiments, the first function includes initiating a routing operation to a waypoint (e.g., displaying an orienteering user interface that includes navigational indications directing a user to a waypoint) and/or pausing an ongoing routing operation to a waypoint. In some embodiments, the first function includes initiating a flashlight operation of the computer system (e.g., turning on a flashlight of the computer system and/or displaying a bright white user interface). In some embodiments, the first function includes starting a workout (e.g., 616A in FIG. 6E) (e.g., initiating an operation that monitors, measures, and/or tracks one or more biometric features (e.g., heart rate), movement, and/or location of a user of the computer system), starting a new lap and/or leg of an ongoing workout (e.g., separating the ongoing workout into different portions so that a user can track and/or monitor progress over respective portions of the ongoing workout), pausing the ongoing workout (e.g., pausing an operation that monitors, measures, and/or tracks one or more biometric features (e.g., heart rate), movement, and/or location of a user of the computer system). In some embodiments, the first function includes initiating a stopwatch (e.g., 655 in FIG. 6O) (e.g., initiating a timer that tracks an amount of time that has elapsed since initiating the stopwatch function), starting a new lap and/or leg of an ongoing stopwatch (e.g., separating an ongoing timer into different portions and/or intervals), and/or pausing the ongoing stopwatch (e.g., pausing a timer that tracks an amount of time that has elapsed since initiating the stopwatch function). In some embodiments, the first function includes starting a dive (e.g., starting a timer that tracks an amount of time at which a user of the computer system has been scuba diving and/or tracking, monitoring, and/or sensing a depth and/or other characteristics of the scuba dive) and/or performing a dynamic action for an ongoing dive (e.g., decompression timer). In some embodiments, the duration of the activation event includes (e.g., is and/or is defined as) the time from when the one or more input devices was activated (e.g., a press gesture directed to one or more buttons was detected) to the end of activation event (e.g., when the press gesture directed to one or more physical buttons is no longer detected (e.g., lift off and/or ceasing to press the button)). In some embodiments, the duration of the activation event includes the time from when the one or more input devices was activated (e.g., a press gesture directed to one or more buttons was detected) to a respective time where the one or more input devices was still being activated (e.g., while the press gesture directed to one or more physical buttons is still being detected before detecting the end (e.g., lift off and/or ceasing to press the button) of the activation event). In response to detecting the activation event (e.g., 650B) and in accordance with a determination that the activation event (e.g., 650B) ends within a second period of time (e.g., a time between 611A and 611B), wherein the second period of time (e.g., a time between 611A and 611B) starts after (or, in some instances, at the same time as when) the first time threshold (e.g. 611A) has elapsed (e.g., the activation event ends after the first period of time and before a third period of time; the activation event ends after a first time threshold and before a second time threshold; and/or a duration of the activation event (from a beginning of the activation event to an end of the activation event) is greater than (or, in some embodiments, is greater than or equal to) the first threshold amount of time and less than (or, in some embodiments, is less than or equal to) a second threshold amount of time, such as 0.0001, 0.001, 0.01, 0.1, 0.5, 1, 3, 5, or 10 seconds), and wherein the second period of time (e.g., a time between 611A and 611B) is different from the first period of time (e.g., a time between zero and 611A) (e.g., the second period of time begins after the first period of time; and/or the first period of time and the second period of time are mutually exclusive), the computer system (e.g., 600) displays (706), via one or more display generation components (e.g., 602), a user interface (e.g., 640 in FIG. 6G) (e.g., a menu and/or one or more selectable user interface elements) for selecting (e.g., changing, switching, and/or editing) a different function (e.g., a function corresponding to one of 642A-642E) to be associated with the first input device (e.g., 606A) (e.g., a user interface for selecting a second function, different from the first function, to be associated with the first input device). In some embodiments, the activation event includes concurrently or consecutively pressing multiple input devices of the one or more input devices. In some embodiments, the activation event includes pressing a single input device of the one or more input devices. In some embodiments, selecting the first function associated with the first input device includes associating the first function with the first input device for the first time (e.g., no function is associated with the first input device prior to detecting the activation event). In some embodiments, a new waypoint includes information about a physical location (e.g., latitude, longitude, and/or elevation) in which the computer system is located when the user input and/or the end of the user input is detected. In some embodiments, the new waypoint is configured to, when selected via user input, cause the computer system to determine and/or provide (e.g., display and/or output) a route, directions, and/or orienteering guidance from a current physical location of the computer system to a location associated with the new waypoint. In some embodiments, the computer system stores the new waypoint when adding the new waypoint, such that the new waypoint can be viewed and/or selected in an application (e.g., a location tracking an application and/or a compass application) associated with the new waypoint. In some embodiments, a shortcut operation of the computer system includes performing one or more operations, launching one or more applications, and/or initiating one or more tasks that are associated with a respective time of day (e.g., waking up, commuting to work, taking a break, commuting home, and/or going to sleep) and/or associated with a respective routine of a user of the computer system. For example, in some embodiments, the shortcut operation includes providing directions from a first location to a second location via a map application of computer system, sending a message to a respective contact stored in computer system via a messaging application of computer system, initiating output of a media item via an audio device (e.g., a speaker and/or headphones) in communication with computer system, and/or setting an alarm via a clock and/or alarm application of computer system. In some embodiments, the computer system performs the shortcut operation in response to receiving a voice command and/or other user input requesting to initiate the shortcut operation. Providing a mechanism that differentiates between different types of inputs (e.g., a short press and a long press) on the same button aids in discerning user intent. For example, upon a brief activation that ends within a predetermined first threshold, the system promptly performs a pre-programmed primary action, eliminating any delay in response and increases the operational efficiency of the computer system. On the other hand, if the activation extends beyond the predetermined threshold, the computer system is able to discern such an input as the user's desire for configuration changes, thereby displaying a user interface personalized for adjustment of the button's function. As a result, the system enables a multi-purpose operation of the single configurable button, thus reducing the number of physical buttons required on the computer system and simplifying the user experience. Consequently, the computer system's usability is improved by tailoring button functions to user preference but also significantly minimizing input errors by reducing the number of inputs needed to perform/or edit the function.

In some embodiments, in response to detecting the activation event (e.g., 650B) and in accordance with a determination that the activation event (e.g., 650B) ends within the first period of time (e.g., a time between zero and 611A) and the first input device (e.g., 606A) is associated with a second function (e.g., a function corresponding to one of 642A-642E) that is different from the first function, computer system (e.g., 600) initiates a process for performing the second function (e.g., a function corresponding to one of 642A-642E, user interface displayed in FIG. 6E, 6O, or 6Q) (e.g., the computer system performs the second function and/or displays one or more selectable user interface elements for initiating the second function). In some embodiments, the computer system initiates the process for performing the second function without initiating the process for performing the second function and/or without displaying the user interface for selecting a different function to be associated with the first input device. In some embodiments, the second function includes adding a new waypoint (e.g., a location that includes a latitude, longitude, and/or elevation) to a location tracking and/or compass application). In some embodiments, the second function includes initiating a shortcut operation of the computer system (e.g., performing one or more predefined and/or user selected operations that are associated with a voice assistant application and/or a shortcut application of the computer system). In some embodiments, the second function includes initiating a routing operation to a waypoint (e.g., displaying an orienteering user interface that includes navigational indications directing a user to a waypoint) and/or pausing an ongoing routing operation to a waypoint. In some embodiments, the second function includes initiating a flashlight operation of the computer system (e.g., turning on a flashlight of the computer system and/or displaying a bright white user interface). In some embodiments, the second function includes starting a workout (e.g., initiating an operation that monitors, measures, and/or tracks one or more biometric features (e.g., heart rate), movement, and/or location of a user of the computer system), starting a new lap and/or leg of an ongoing workout (e.g., separating the ongoing workout into different portions so that a user can track and/or monitor progress over respective portions of the ongoing workout), pausing the ongoing workout (e.g., pausing an operation that monitors, measures, and/or tracks one or more biometric features (e.g., heart rate), movement, and/or location of a user of the computer system). In some embodiments, the second function includes initiating a stopwatch (e.g., initiating a timer that tracks an amount of time that has elapsed since initiating the stopwatch function), starting a new lap and/or leg of an ongoing stopwatch (e.g., separating an ongoing timer into different portions and/or intervals), and/or pausing the ongoing stopwatch (e.g., pausing a timer that tracks an amount of time that has elapsed since initiating the stopwatch function). In some embodiments, the second function includes starting a dive (e.g., starting a timer that tracks an amount of time at which a user of the computer system has been scuba diving and/or tracking, monitoring, and/or sensing a depth and/or other characteristics of the scuba dive) and/or performing a dynamic action for an ongoing dive (e.g., decompression timer). Performing a second function in response to a button press allows for rapid and responsive execution of a secondary action when a button press duration culminates within a first threshold. This approach allows for a more seamless interaction where users can quickly engage with the computer system to activate a distinct, secondary function without navigating through additional menus or interfaces, and, as a result, reduces the number of inputs needed to perform the second function.

In some embodiments, in response to detecting the activation event (e.g., 650B) and in accordance with a determination that the activation event (e.g., 650B) ends after the second period of time (e.g., a time after 611B) (e.g., the activation event ends after the first period of time and after the second period of time; the activation event ends after a first time threshold and after a second time threshold; and/or a duration of the activation event (from a beginning of the activation event to an end of the activation event) is greater than (or, in some embodiments, is greater than or equal to) the first threshold amount of time and greater than (or, in some embodiments, is greater than or equal to) the second threshold amount of time, such as 0.0001, 0.001, 0.01, 0.1, 0.5, 1, 3, 5, or 10 seconds), the computer system (e.g., 600) initiates a process for performing a system function (e.g., a system function corresponding to one of 682A-682D in FIG. 6R) that is different from the first function (e.g., a function corresponding to one of 642A-642E) (e.g., the computer system performs the system function and/or displays one or more selectable user interface elements for performing the system function). In some embodiments, the system function is a function that is part of an operating system corresponding to the computer system. In some embodiments, the system function does not correspond to any specific application on the computer system. In some embodiments, the system function is used to manage and/or facilitate performance and/or capabilities of the computer system. In some embodiments, the system function is associated with timekeeping (e.g., displaying the time and date; and/or displaying/changing alarms, timers, and world clock). In some embodiments, the system function is associated with initiating a communication (e.g., initiating a call such as, to an emergency dispatch service and/or to a predetermined contact, initiating a message such as a text, audio, and/or video message, activating an emergency siren, and/or displaying a medical identification user interface). In some embodiments, the system function corresponds to an emergency siren system function that, when activated, causes the computer system to emit a distinctive and high-volume siren sound pattern intended to signal distress and attract attention in emergency situations. In some embodiments, activating the emergency siren system function includes the computer system sending an automated alert message with a location of the user of the computer system to a predetermined contact(s) or services. In some embodiments, the system function corresponds to a medical identification option that, when activated, causes display of information about a user of the computer system, such as age, height, weight, blood type, organ donor status (e.g., organ donor or non-organ donor), and/or emergency contact information (e.g., name, phone number, address, and/or other contact information, such as email address). In some embodiments, the system function corresponds to an emergency phone call option that, when activated, causes the computer system to initiate an outgoing phone call to an emergency services phone number (e.g., 911 and/or another local emergency services phone number). In some embodiments, the system function corresponds to a compass backtrack option, that, when activated, provides visual cues and directional assistance to a user of the computer system to guide them back along their inbound path. In some embodiments, the compass backtrack option works without the computer system having cellular connectivity and uses the computer system's sensors (GPS, gyroscope, accelerometer, barometer, and/or altimeter), ensuring reliability even in remote locations. In some embodiments, the system function is associated with health and/or fitness tracking (e.g., heart rate monitoring, step counting, workout tracking, and/or health data management). In some embodiments, the system function is associated with payment processing (e.g., initiating a process for performing a mobile payment). In some embodiments, the system function is associated with modifying system settings (e.g., changing a time interface and/or setting, adjusting a watch face interface, changing a brightness setting, changing a system sound, and/or changing a system haptic output setting). Performing a system function in response to detecting an activation event (e.g., button press) allows for rapid and responsive execution of a system action when a button press duration ends after the second threshold. This approach allows for a more seamless interaction where users can quickly engage with the computer system to activate a distinct, system function without navigating through additional menus or interfaces, and, as a result, reduces the number of inputs needed to perform the system function.

In some embodiments, the computer system (e.g., 600) detects, via the one or more input devices, a second activation event (e.g., 650B or an additional input via first input device (e.g., 606A)) that includes activation of the first input device (e.g., 606A) of the one or more input devices (e.g., 606A-606C) (e.g., a press of a button, activation of a button, and/or deactivation of a button); and in response to detecting the second activation event (e.g., 650K in FIG. 6M) and in accordance with a determination that the first input device (e.g., 606A) is associated with the second function (e.g., a function corresponding to one of 642A-642E) that is different from the first function (e.g., a function corresponding to one of 642A-642E) and that the second activation (e.g., 650K in FIG. 6M) event ends after the second period of time (e.g., a respective time after 611B) (e.g., the second activation event ends after the first period of time and after the second period of time; the second activation event ends after a first time threshold and after a second time threshold; and/or a duration of the second activation event (from a beginning of the second activation event to an end of the second activation event) is greater than (or, in some embodiments, is greater than or equal to) the first threshold amount of time and greater than (or, in some embodiments, is greater than or equal to) the second threshold amount of time, such as 0.0001, 0.001, 0.01, 0.1, 0.5, 1, 3, 5, or 10 seconds), the computer system (e.g., 600) initiates a process (e.g., displays system function user interface 680 in FIG. 6R) for performing the system function (e.g., a system function corresponding to one of 682A-682D in FIG. 6R) that is different from the first function (e.g., a function corresponding to one of 642A-642E) and is different from the second function (e.g., a function corresponding to one of 642A-642E). In some embodiments, the system function is independent of (e.g., unrelated to, does not correspond to, is not associated with, and/or is separate from) a respective function (e.g., the first function, the second function, or a third function) corresponding to the first input device. In some embodiments, the respective function is a function that is initiated in response to activation/selection of the first input device. Providing a system function that is independent of a configuration of the first input device ensures that essential system functions are consistently maintained, providing a stable and dependable user experience. As a result, system functions remain accessible and unaltered, thereby preventing any inadvertent modifications that could otherwise arise from user interface customization. This approach provides reliability, ensures operational consistency, and fosters an intuitive user experience. Additionally, this approach allows for a more seamless interaction where users can quickly engage with the computer system to activate a distinct, system function without navigating through additional menus or interfaces, and, as a result, reduces the number of inputs needed to perform the system function.

In some embodiments, performing the system function (e.g., a system function corresponding to one of 682A-682D in FIG. 6R) includes outputting an audible alert (e.g., audio 695 via audio output device 603) (e.g., activating an audible emergency alert, a beacon, and/or an audio tone). In some embodiments, outputting an audible alert includes outputting an emergency siren (e.g., a sequence of audio output bursts and/or continuous audio output above a predetermined volume level (such as above 60 decibels, above 70 decibels, above 80 decibels, and/or above 85 decibels) that is, optionally, designed to provide an audible indication of a location of a user in need of assistance) that is configured to continue after no longer detecting the activation event. In some embodiments, the computer system continues to output the emergency siren after detecting the end of the activation event when the user input has been maintained for a predetermined amount of time (e.g., maintained throughout a countdown timer associated with the emergency siren). Outputting an audio alert as a system function facilitates an ability of the user to signal for help in an emergency situation, which provides the computer system with enhanced safety features.

In some embodiments, initiating the process for performing the system function (e.g., a system function corresponding to one of 682A-682D in FIG. 6R) that is different from the first function includes: in accordance with a determination that the activation event (e.g., 650B) ends after the second period of time (e.g., a respective time after 611B) and within a third period of time (e.g., a respective time between 611B and 611C), wherein the third period of time starts after (or, in some instances, at the same time as) a second time threshold (e.g., 611B) has elapsed (e.g., the activation event ends after the first period of time and after the second period of time; the activation event ends after a first time threshold and after a second time threshold; and/or a duration of the activation event (from a beginning of the activation event to an end of the activation event) is greater than (or, in some embodiments, is greater than or equal to) the first threshold amount of time and greater than (or, in some embodiments, is greater than or equal to) the second threshold amount of time, such as 0.0001, 0.001, 0.01, 0.1, 0.5, 1, 3, 5, or 10 seconds), computer system (e.g., 600) displays, via the one or more display generation components (e.g., 602), a user interface that includes a set of one or more options (e.g., 682A-682D in FIG. 6R) (e.g., a set of one more interface elements, controls, widgets, buttons, selectable icons, selectable graphical objects, manipulable components, affordances, and/or toggles) for initiating (e.g., 692 in FIG. 6T) (e.g., performing, running, and/or starting) the system function (e.g., a system function corresponding to one of 682A-682D in FIG. 6R). In some embodiments, the interface includes a set of one or more options for terminating the system function. In some embodiments, the system function corresponds to an emergency siren system function that, when activated, causes the computer system to emit a distinctive and high-volume siren sound pattern intended to signal distress and attract attention in emergency situations. In some embodiments, activating the emergency siren system function includes the computer system sending an automated alert message with a location of the user of the computer system to a predetermined contact(s) or services. In some embodiments, the system function corresponds to a medical identification option that, when activated, causes display of information about a user of the computer system, such as age, height, weight, blood type, organ donor status (e.g., organ donor or non-organ donor), and/or emergency contact information (e.g., name, phone number, address, and/or other contact information, such as email address). In some embodiments, the system function corresponds to an emergency phone call option that, when activated, causes the computer system to initiate an outgoing phone call to an emergency services phone number (e.g., 911 and/or another local emergency services phone number). In some embodiments, the system function corresponds to a compass backtrack option, that, when activated, provides visual cues and directional assistance to a user of the computer system to guide them back along their inbound path. In some embodiments, the compass backtrack option works without the computer system having cellular connectivity and uses the computer system's sensors (GPS, gyroscope, accelerometer, barometer, and/or altimeter), ensuring reliability even in remote locations. Displaying the user interface with a selectable option(s) to perform the system function allows the user to confirm or cancel the execution of significant system functions, providing an added layer of control and preventing accidental activation of potentially disruptive actions. Further, this approach allows for a more seamless interaction where users can choose to perform the specific system function without navigating through additional menus or interfaces, and, as a result, reduces the number of inputs needed to perform the system function.

In some embodiments, initiating the process for performing the system function (e.g., a system function corresponding to one of 682A-682D in FIG. 6R) that is different from the first function further includes: in accordance with a determination that the activation event (e.g., 650B) ends after the second period of time (e.g., a respective time after 611B) and after the third period of time (e.g., a respective time after 611C), initiating (e.g., 692 in FIG. 6T, also outputting of audio 695) (e.g., performing, running, and/or starting) the system function (e.g., a system function corresponding to one of 682A-682D in FIG. 6R). Performing the system function in the activation of the first input device ends after a third provides an ability for the user to signal for help in an emergency situation more quickly, which provides the computer system with enhanced safety features and reduces the number of inputs needed to perform an operation.

In some embodiments, in accordance with a determination that detecting the activation event (e.g., 650B) occurs while the computer system (e.g., 600) is displaying a first interface (e.g., user interface 604) (e.g., a time interface, watch face, lock screen, wake screen, and/or an application interface), the second period of time (e.g., the time between 611B and 611C) has a first duration (e.g., 0.0001, 0.001, 0.01, 0.1, 0.5, 1, 3, 5, or 10 seconds). In some embodiments, in accordance with a determination that detecting the activation event (e.g., 650B) occurs while the computer system is displaying the user interface (e.g., 640 in FIG. 6J) (e.g., a menu and/or one or more selectable user interface elements) for selecting (e.g., changing, switching, and/or editing) a different function to be associated with the first input device (e.g., 606A), the second period of time (e.g., the time between 611B and 611C) has a second duration (e.g., 0.0001, 0.001, 0.01, 0.1, 0.5, 1, 3, 5, or 10 seconds) that is shorter than (or, optionally longer than) the first duration. Requiring a longer activation input to get to system function if starting from time interface or an app interface as compared to the activation event if starting from the user interface for switching the function of the configurable button provides for quicker access to the system function from the user interface for switching the function, which provides the computer system with enhanced safety features and reduces the number of inputs needed to perform an operation.

In some embodiments, the computer system (e.g., 600) detects, via the one or more input devices (e.g., 606A-606C), a second activation event (e.g., 650K in FIG. 6M) that includes activation of a second input device (e.g., 606B) of the one or more input devices (e.g., a press of a button, activation of a button, and/or deactivation of a button), different from the first input device (e.g., 606A). In some embodiments, the second activation event includes a beginning (e.g., an activation of a button, such as a press of a button) and an end (e.g., deactivation of the button, such as release of the button). In some embodiments, in response to detecting the second activation event (e.g., 650K in FIG. 6M), the computer system (e.g., 600) initiates the process (e.g., displays system function user interface 680 in FIG. 6R) for performing the system function (e.g., a system function corresponding to one of 682A-682D in FIG. 6R) (e.g., the computer system performs the system function and/or displays one or more selectable user interface elements for performing the system function). In some embodiments, the second activation event is detected while displaying a time interface (e.g., a watch face, wake screen, lock screen, application interface, application springboard, and/or a home screen). Providing access to the system function via various input mechanisms provides the user with the ability to signal for help in an emergency situation more quickly, which provides the computer system with enhanced safety features and reduces the number of inputs needed to perform an operation.

In some embodiments, displaying the user interface (e.g., function selection interface 640 in FIG. 6J) for selecting a different function (e.g., a function corresponding to one of 642A-642E) to be associated with the first input device (e.g., 606A) includes displaying a plurality of graphical objects (e.g., 642A-642E in FIG. 6G) corresponding to a plurality of functions, wherein the plurality of graphical objects include: a first graphical object (e.g., one of 642B-642E in FIG. 6G) (e.g., affordance, icon, and/or button) corresponding to a first candidate function that is different from a currently selected function (e.g., function corresponding to 642A in FIG. 6G); and a second graphical object (e.g., one of 642B-642E in FIG. 6G) corresponding to a second candidate function that is different from the currently selected function (e.g., function corresponding to 642A in FIG. 6G) and is different from the first function. Displaying a plurality of options on the user interface for switching the function to be associated with the first input device allows users to adapt the button's functionality to their individual needs, situational requirements, or personal preferences, enhancing the computer system's versatility. The plurality of options allows for on-the-fly adjustments to the first input device's operation, which reduces the number of inputs needed to perform an operation.

In some embodiments, while displaying the first graphical object (e.g., one of 642B-642E in FIG. 6G) and the second graphical object (e.g., one of 642B-642E in FIG. 6G), the computer system (e.g., 600) detects, via the one or more input devices (e.g., 606A-606C), an input (e.g., input 650E in FIG. 6J) (e.g., touch input(s), rotational input(s), press input(s), swipe input(s), an input using a mouse/cursor, and/or air gesture(s)) directed to a respective graphical object (e.g., one of 642A-642E in FIG. 6I) from the plurality of graphical objects (e.g., one of 642B-642E in FIG. 6I). In some embodiments, in response to detecting the input (e.g., input 650E in FIG. 6J) directed to the respective graphical object (e.g., one of 642B-642E in FIG. 6I) from the plurality of graphical objects and in accordance with a determination that the input (e.g., input 650E in FIG. 6J) is directed to the first graphical object (e.g., “Waypoint” 642C in FIG. 6I), the computer system (e.g., 600) selects the first candidate function as the currently selected function. In some embodiments, in response to detecting the input (e.g., input 650E in FIG. 6J) directed to the respective graphical object (e.g., one of 642B-642E in FIG. 6I) from the plurality of graphical objects (e.g., one of 642B-642E in FIG. 6I) and in accordance with a determination that the input (e.g., input 650E in FIG. 6I) is directed to the second graphical object (e.g., one of 642A, and 642C-642E in FIG. 6I), the computer system (e.g., 600) selects the second candidate function as the currently selected function. In some embodiments, selecting the respective graphical object includes switching a respective function associated with the first input device with a respective function corresponding to the selected respective graphical object (e.g., without detecting additional inputs). In some embodiments, selecting the respective graphical object does not include switching a respective function associated with the first input device with a respective function corresponding to the selected respective graphical object. In some embodiments, selecting the respective graphical object includes highlighting the selected respective graphical object (e.g., moving a focus indicator to the selected respective graphical object). In some embodiments, while the respective graphical object is selected, the computer system detects, via the one or more input devices, an additional input, and, in response to detecting the additional input, the computer system switches the respective function associated with the first input device with the respective function corresponding to the selected respective graphical object. In some embodiments, the respective graphical object corresponds to the different function. While displaying a plurality of options on the user interface for switching the function to be associated with the first input device, selecting a respective option via a tap input allows users to quickly select their desired choice, which reduces the number of inputs needed to perform an operation.

In some embodiments, the one or more input devices (e.g., 606A-606C) includes a rotatable input mechanism (e.g., 606C) (e.g., a rotatable and depressible input mechanism and/or an input device that rotates around an axis). In some embodiments, while displaying the plurality of graphical objects (e.g., 642A-642E in FIG. 6G) corresponding to the plurality of functions and while a first respective graphical object (e.g., 642A in FIG. 6G) from the plurality of graphical objects (e.g., 642A-642E in FIG. 6G) has input focus (e.g., 642A in FIG. 6G as indicated by the dashed outline) (e.g., is highlighted, flagged, marked, and/or a selection indicator is displayed around/on the graphical object), the computer system (e.g., 600) detects, via the rotatable input mechanism (e.g., 606C), an input (e.g., 650C in FIG. 6G and/or 650C in FIG. 6H) that includes rotation of the rotatable input mechanism (e.g., 606C) (e.g., a clockwise rotational input and/or a counterclockwise rotational input). In some embodiments, in response to detecting the input (e.g., 650C in FIG. 6G and/or 650C in FIG. 6H) that includes rotation of the rotatable input mechanism (e.g., 606C), the computer system (e.g., 600) selects a second respective graphical object (e.g., 642B in FIG. 6I as indicated by the dashed outline) from the plurality of graphical objects that is different from the first respective graphical object. In some embodiments, selecting the second respective graphical object from the plurality of graphical objects includes deselecting the first respective graphical object from the plurality of graphical objects. In some embodiments, selecting the second respective graphical object from the plurality of graphical objects includes moving a focus indictor from the first respective graphical object to the second respective graphical object. In some embodiments, the second respective graphical object corresponds to the different function. In some embodiments, selecting the second respective graphical object includes switching a respective function associated with the first input device with a respective function corresponding to the second respective graphical object (e.g., without detecting additional inputs). In some embodiments, selecting the second respective graphical object does not include switching a respective function associated with the first input device with a respective function corresponding to the second selected respective graphical object. In some embodiments, selecting the second respective graphical object includes highlighting the selected respective graphical object. In some embodiments, while the second respective graphical object is selected, the computer system detects, via the one or more input devices, an additional input, and, in response to detecting the additional input, the computer system switches the respective function associated with the first input device with the respective function corresponding to the selected second respective graphical object. While displaying a plurality of options on the user interface for switching the function to be associated with the first input device, selecting a respective option via a rotatable input mechanism allows users to quickly scroll and select their desired choice via a single input, which reduces the number of inputs needed to perform an operation.

In some embodiments, while displaying the plurality of graphical objects (e.g., 642A-642E in FIG. 6J) corresponding to the plurality of functions, the computer system (e.g., 600) detects, via the rotatable input mechanism (e.g., 606C), a press input (e.g., 650H in FIG. 6J) (e.g., a single press or a double press of the rotatable input mechanism). In some embodiments, in response to detecting the press input (e.g., 650H in FIG. 6J), the computer system (e.g., 600) ceases displaying the user interface (e.g., 640) for selecting a different function to be associated with the first input device (e.g., 606A) without associating (e.g., not changing, not switching, and/or not editing) a respective function corresponding to a currently selected graphical object (e.g., 642C in FIG. 6J, 642B in FIG. 6I) (e.g., the second respective graphical object) from the plurality of graphical objects (e.g., 642A-642E in FIG. 6J) with the first input device (e.g., 606A). In some embodiments, in response to detecting the press input, the computer system, forgoes associating the respective function with the first input device and maintains displaying the plurality of graphical objects corresponding to the plurality of functions. In some embodiments, forgoing associating the respective function with the first input device includes deselecting at least one graphical object (e.g., the graphical object(s) that was previously selected) from the plurality of graphical object. In some embodiments, forgoing associating the respective function with the first input device includes maintaining a respective function that was associated with the first input device prior to detecting the activation event. While displaying a plurality of options on the user interface for switching the function to be associated with the first input device, cancelling selection of the desired function via a press input of the rotatable input mechanism allows for a user to quickly cancel changing the function, which ultimately reduces the number of inputs needed to perform an operation as the user does not need to undo an undesired change.

In some embodiments, displaying the plurality of graphical objects (e.g., 642A-642E in FIG. 6G) (e.g., affordances, icons, and/or buttons) corresponding to the plurality of functions includes displaying a focus indicator (e.g., 645 in FIG. 6G, dashed line around 642A) (e.g., marker, cursor, border and/or frame around a graphical object, and/or selection indicator) corresponding to a graphical object (e.g., 642A in FIG. 6G) from the plurality of graphical objects that currently has input focus. In some embodiments, the computer system (e.g., 600) detects, via the one or more input devices (e.g., 606A-606C), an input (e.g., 650C in FIG. 6G) (e.g., tap, press of a button, rotation of a rotatable input mechanism, air gesture, and/or mouse input) for moving the focus indicator (e.g., 645 in FIG. 6G, dashed line around 642A). In some embodiments, in response to detecting the input (e.g., 650C in FIG. 6G) for moving the focus indicator (e.g., 645 in FIG. 6G, dashed line around 642A): while moving the focus indicator (e.g., 645 in FIG. 6G, dashed line around 642A) from the graphical object that currently has input focus (e.g., 642A in FIG. 6G) to a different graphical object (e.g., 642B in FIG. 6H and FIG. 6I), the computer system (e.g., 600) changes, via the one or more display generation components (e.g., 602), an appearance (e.g., size, color, and/or brightness) of the focus indicator (e.g., 645 in FIG. 6H). In some embodiments, the different graphical object is selected in response to detecting a rotation input via the rotatable input mechanism. In some embodiments, the different graphical object is selected in response to detecting one of a touch input(s), press input(s), swipe input(s), an input using a mouse/cursor, and/or air gesture(s). In some embodiments, the focus indicator expands (such as enlarges, grows, inflates, stretches, widens, swells, extends, broadens, increases in size, magnifies, and/or balloons) or contracts (such as shrinks, diminishes, deflates, compresses, narrows, recedes, retracts, condenses, decreases in size, and/or collapses) when focus indicator moves over the newly selected graphical object. In some embodiments, the focus indicator changes appearance when it is fully over the newly selected graphical object. In some embodiments, the focus indicator changes appearance when it is partially over the newly selected graphical object. Changing the appearance of a visual indicator when it is moved over a selectable option helps to focus the user's attention on the currently selected option, thereby providing improved visual feedback and reducing errors and/or unnecessary inputs to correct errors.

In some embodiments, displaying the plurality of graphical objects (e.g., 642A-642E in FIG. 6G) (e.g., affordances, icons, and/or buttons) corresponding to the plurality of functions includes: the computer system (e.g., 600) displaying, via the one or more display generation components (e.g., 602), a focus indicator (e.g., 645 in FIG. 6G) (e.g., marker, cursor, border and/or frame around a graphical object, and/or focus indicator) corresponding to a graphical object (e.g., 642A in FIG. 6G) from the plurality of graphical objects (e.g., 642A-642E in FIG. 6G) that currently has input focus; and the computer system (e.g., 600) changing, via the one or more display generation components (e.g., 602), an appearance (e.g., size, color, and/or brightness) of the focus indicator (e.g., 645 in FIG. 6H) while moving the focus indicator (e.g., focus indicator 645 changes in appearance as it moves from FIG. 6G to FIG. 6H). In some embodiments, the focus indicator moves in response to detecting one of a touch input(s), rotational input(s), press input(s), swipe input(s), an input using a mouse/cursor, and/or air gesture(s). In some embodiments, the focus indicator expands or contracts while it is moving. Changing the appearance of a visual indicator while it is moving helps to focus the user's attention on the visual indicator's location, thereby providing improved visual feedback and reducing errors and/or unnecessary inputs to correct errors.

In some embodiments, displaying the plurality of graphical objects (e.g., 642A-642E in FIG. 6I) (e.g., affordances, icons, and/or buttons) corresponding to the plurality of functions includes displaying a focus indicator (e.g., 645 in FIG. 6I) (e.g., marker, cursor, border and/or frame around a graphical object, and/or focus indicator) corresponding to a graphical object (e.g., 642B in FIG. 6I) from the plurality of graphical objects that currently has input focus, wherein the focus indicator visually pulses (e.g., 645 in FIG. 6I, as shown via the dashed lines) (e.g., a brightness changes, color changes, and/or size of the focus indicator increases and decreases over a period of time). In some embodiments, the focus indicator periodically pulses around the graphical object that currently has input focus. Displaying the visual indicator as visually pulsating helps to focus the user's attention on the option that has input focus, thereby providing improved visual feedback and reducing errors and/or unnecessary inputs to correct errors.

In some embodiments, while displaying the plurality of graphical objects (e.g., 642A-642E in FIG. 6J) corresponding to the plurality of functions, the computer system (e.g., 600) detects, via the one or more input devices (e.g., 606A-606C), an input (e.g., 650I in FIG. 6J) that includes activation of the first input device (e.g., 606A) (e.g., a press of a button, activation of a button, and/or deactivation of a button). In some embodiments, in response to detecting the input (e.g., 650I in FIG. 6J) that includes activation of the first input device (e.g., 606A), the computer system (e.g., 600) associates with the first input device (e.g., 606A) a respective function corresponding to a graphical object (e.g., 642C in FIG. 6J, “Waypoint”) that currently has input focus from the plurality of graphical objects (e.g., 642A-642E in FIG. 6J) corresponding to the plurality of functions. In some embodiments, the respective function is the same function (e.g., the function stays the same) as the function that was associated with the with the first input device prior to detecting the activation event. In some embodiments, the respective function is a different function (e.g., the function changes) from the function that was associated with the with the first input device prior to detecting the activation event. In some embodiments, activating the first input device while the respective function corresponding to the graphical object that has input focus is associated with the first input device causes the computer system to initiate a process for performing the function corresponding to the graphical object that has input focus. While displaying a plurality of options on the user interface for switching the function to be associated with the first input device, confirming selection of the desired function via a press input allows for a user to confirm their desired choice, which minimizes the potential for the user to accidently select the wrong option, and, as a result reduces the number of inputs needed to select a desired option.

In some embodiments, while displaying the plurality of graphical objects (e.g., 642A-642E in FIG. 6J) corresponding to the plurality of functions, the computer system (e.g., 600) detects, via the one or more input devices (e.g., 606A-606C), an activation input (e.g., 650I in FIG. 6J) that includes activation of the first input device (e.g., 606A) (e.g., a press of a button, activation of a button, and/or deactivation of a button). In some embodiments, in response to detecting the activation input (e.g., 650I in FIG. 6J) that includes activation of the first input device (e.g., 606A) and in accordance with a determination that a duration of the activation input (e.g., 650I in FIG. 6J) is less than (or, in some embodiments, equal to) a predetermined time threshold (e.g., less than 611A in duration indicator 610L), the computer system (e.g., 600) associates with the first input device (e.g., 606A) a respective function corresponding to a graphical object (e.g., 642C in FIG. 6J) from the plurality of graphical objects that currently has input focus (e.g., 642C in FIG. 6J). In some embodiments, the respective function is the same function (e.g., the function stays the same) as the function that was associated with the with the first input device prior to detecting the activation event. In some embodiments, the respective function is a different function (e.g., the function changes) from the function that was associated with the with the first input device prior to detecting the activation event. In some embodiments, in response to detecting the activation input (e.g., 650I in FIG. 6J) that includes activation of the first input device (e.g., 606A) and in accordance with a determination that the duration of the activation input (e.g., 650I in FIG. 6J) is greater than (or, in some embodiments, equal to) the predetermined time threshold (e.g., greater than 611B in duration indicator 610L), the computer system (e.g., 600) initiates a process for performing the system function (e.g., a system function corresponding to one of 682A-682D in FIG. 6R) (e.g., the computer system performs the system function and/or displays one or more selectable user interface elements for performing the system function). In some embodiments, activating the first input device while the respective function corresponding to the currently selected graphical object is associated with the first input device causes the computer system to initiate a process for performing the function corresponding to the currently selected graphical object. Performing a system function in response to detecting an activation event (e.g., button press) while in the configuration user interface allows for rapid and responsive execution of a system action when a button press duration exceeds a predetermined threshold. This approach allows for a more seamless interaction where users can quickly engage with the computer system to activate a distinct, system function without navigating through additional menus or interfaces, and, as a result, reduces the number of inputs needed to perform the system function.

In some embodiments, while displaying the plurality of graphical objects (e.g., 642A-642E in FIG. 6J) corresponding to the plurality of functions, the computer system (e.g., 600) detects, via the one or more input devices (e.g., 606A-606C), a confirmation input (e.g., 650I in FIG. 6J) (e.g., a press of a button, activation of a button, and/or deactivation of a button). In some embodiments, in response to detecting the confirmation input (e.g., 650I in FIG. 6J), the computer system (e.g., 600) associates with the first input device (e.g., 606A) a respective function corresponding to a respective graphical object (e.g., 643C in FIG. 6J) from the plurality of graphical objects (e.g., 642A-642E in FIG. 6J) corresponding to the plurality of functions, wherein the respective graphical object (e.g., 643C in FIG. 6J) currently has input focus (e.g., as represented by dashed outline of focus indicator 645 in FIG. 6J). In some embodiments, the respective function is the same function (e.g., the function stays the same) as the function that was associated with the with the first input device prior to detecting the activation event. In some embodiments, the respective function is a different function (e.g., the function changes) from the function that was associated with the with the first input device prior to detecting the activation event. In some embodiments, response to detecting the confirmation input (e.g., 650I in FIG. 6J), the computer system (e.g., 600) displays, via the one or more display generation components 602, a visual feedback element (e.g., transition animation as depicted in confirmation transition interface 646 in FIG. 6L) (e.g., an animation, visual effect, distortion, textual indicator, and/or graphical indicator) that provides visual feedback to the user that the respective function corresponding to the respective graphical object (e.g., 643C in FIG. 6J) has been associated with the first input device (e.g., 606A). In some embodiments, activating the first input device while the respective function corresponding to the respective graphical object is associated with the first input device causes the computer system to initiate a process for performing the function corresponding to the respective graphical object. Displaying visual feedback when switching a function associated with the first input device provides the user reassurance that the intended action has been acknowledged and executed by the system, thereby, providing improved visual feedback and reducing errors and/or unnecessary inputs to correct errors.

In some embodiments, displaying the visual feedback element (e.g., transition animation as depicted in confirmation transition interface 646 in FIG. 6L) includes distorting (e.g., animating, stretching, compressing, pixilating, morphing, blurring, smearing, adding light too, adding color to, and/or adding visual noise to) a portion of a displayed user interface (e.g., 642A-642E in FIG. 6L are fading) (e.g., the user interface that includes the plurality of graphical objects corresponding to the plurality of functions and/or a time interface such as a watch face and/or lock screen). Displaying visual feedback that includes distorting a portion of the displayed user interface when switching a function associated with the first input device provides the user reassurance that the intended action has been acknowledged and executed by the system, thereby, providing improved visual feedback and reducing errors and/or unnecessary inputs to correct errors.

In some embodiments, while displaying the plurality of graphical objects corresponding to the plurality of functions (e.g., 642A-642E in FIG. 6I), the computer system (e.g., 600) detects, via the one or more input devices (e.g., 606A-606C), a selection input (e.g., an input on 606A or 606C) (e.g., a press of a button, activation of a button, and/or deactivation of a button). In some embodiments, in response to detecting the selection input, (e.g., an input on 606A or 606C) and in accordance with a determination that the selection input includes activation of the first input device (e.g., 606A) of the one or more input devices (e.g., 606A-606C): the computer system (e.g., 600) associates with the first input device (e.g., 606A) a respective function corresponding to a respective graphical object (e.g., 642C in FIG. 6J) from the plurality of graphical objects (e.g., 642A-642C in FIG. 6J), wherein the respective graphical object currently has input focus; and the computer system (e.g., 600) displays, via the one or more display generation components, a first visual effect (e.g., transition animation as depicted in confirmation transition interface 646 in FIG. 6L) (e.g., an animation, visual appearance, distortion, textual indicator, and/or graphical indicator). In some embodiments, in response to detecting the selection input, (e.g., an input on 606A or 606C) and in accordance with a determination that the selection input (e.g., an input on 606C) includes a press input (e.g., 650H) of the rotatable input mechanism (e.g. 606C), the computer system (e.g., 600) displays, via the one or more display generation components (e.g., 602), a second visual effect (e.g., animation user interface 643A-643C in FIGS. 6K-1-6K-3) (e.g., an animation, visual appearance, distortion, textual indicator, and/or graphical indicator) that is different from the first visual effect (e.g., transition animation as depicted in confirmation transition interface 646 in FIG. 6L) without associating (e.g., not changing, not switching, and/or not editing) the respective function corresponding to the respective selected graphical object (e.g., 643C in FIG. 6J) with the first input device (e.g., 606A). In some embodiments, activating the first input device while the respective function corresponding to the respective graphical object is associated with the first input device causes the computer system to initiate a process for performing the function corresponding to the respective graphical object. Displaying different visual effect depending on whether the selection of a new function is canceled or confirmed provides the user reassurance that the intended action has been executed by the system, thereby, providing improved visual feedback and reducing errors and/or unnecessary inputs to correct errors.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve access to various functionality of a computer system. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to suggest preferred functionality of a computer system. Accordingly, use of such personal information data provides users with improved access to various functionality of a computer system. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of providing users with improved access to various functionality of a computer system, the present technology can be configured to allow users to select to “opt in” or “opt out” of participation in the collection of personal information data during registration for services or anytime thereafter. In another example, users can select not to provide access to prior function usage history of the computer system. In yet another example, users can limit access of various functions so as to prevent access to specific undesired functionality of the computer system. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, access to various functionality can be based on non-personal information data or a bare minimum amount of personal information, such as the content being requested by the device associated with a user, other non-personal information available to the user selected service, or publicly available information.

1. A computer system configured to communicate with one or more display generation components and one or more input devices, comprising:
one or more processors; and
memory storing one or more programs configured to be executed by the one or more processors, the one or more programs including instructions for:
detecting, via the one or more input devices, an activation event that includes activation of a first input device of the one or more input devices; and
in response to detecting the activation event:
in accordance with a determination that the activation event ends within a first period of time and the first input device is associated with a first function, wherein the first period of time ends before a first time threshold has elapsed, initiating a process for performing the first function; and
in accordance with a determination that the activation event ends within a second period of time, wherein the second period of time starts after the first time threshold has elapsed, and wherein the second period of time is different from the first period of time, displaying, via the display generation components, a user interface for selecting a different function to be associated with the first input device.

2. The computer system of claim 1, the one or more programs further including instructions for:
in response to detecting the activation event:
in accordance with a determination that the activation event ends within the first period of time and the first input device is associated with a second function that is different from the first function, initiating a process for performing the second function.

3. The computer system of claim 1, the one or more programs further including instructions for:
in response to detecting the activation event:
in accordance with a determination that the activation event ends after the second period of time, initiating a process for performing a system function that is different from the first function.

4. The computer system of claim 3, the one or more programs further including instructions for:
detecting, via the one or more input devices, a second activation event that includes activation of the first input device of the one or more input devices; and
in response to detecting the second activation event, in accordance with a determination that the first input device is associated with a second function that is different from the first function and that the second activation event ends after the second period of time, initiating a process for performing the system function that is different from the first function and is different from the second function.

5. The computer system of claim 3, wherein performing the system function includes outputting an audible alert.

6. The computer system of any one of claims 3-5, wherein initiating the process for performing the system function that is different from the first function includes:
in accordance with a determination that the activation event ends after the second period of time and within a third period of time, wherein the third period of time starts after a second time threshold has elapsed, displaying, via the one or more display generation components, a user interface that includes a set of one or more options for initiating the system function.

7. The computer system of claim 6, wherein initiating the process for performing the system function that is different from the first function further includes:
in accordance with a determination that the activation event ends after the second period of time and after the third period of time, initiating the system function.

8. The computer system of claim 3, wherein:
in accordance with a determination that detecting the activation event occurs while the computer system is displaying a first interface, the second period of time has a first duration; and
in accordance with a determination that detecting the activation event occurs while the computer system is displaying the user interface for selecting a different function to be associated with the first input device, the second period of time has a second duration that is shorter than the first duration.

9. The computer system of claim 3, the one or more programs further including instructions for:
detecting, via the one or more input devices, a second activation event that includes activation of a second input device of the one or more input devices, different from the first input device; and
in response to detecting the second activation event, initiating the process for performing the system function.

10. The computer system of claim 1, wherein displaying the user interface for selecting a different function to be associated with the first input device includes displaying a plurality of graphical objects corresponding to a plurality of functions, wherein the plurality of graphical objects include:
a first graphical object corresponding to a first candidate function that is different from a currently selected function; and
a second graphical object corresponding to a second candidate function that is different from the currently selected function and is different from the first function.

11. The computer system of claim 10, the one or more programs further including instructions for:
while displaying the first graphical object and the second graphical object, detecting, via the one or more input devices, an input directed to a respective graphical object from the plurality of graphical objects; and
in response to detecting the input directed to the respective graphical object from the plurality of graphical objects:
in accordance with a determination that the input is directed to the first graphical object, selecting the first candidate function as the currently selected function; and
in accordance with a determination that the input is directed to the second graphical object, selecting the second candidate function as the currently selected function.

12. The computer system of claim 10, wherein the one or more input devices includes a rotatable input mechanism, the one or more programs further including instructions for:
while displaying the plurality of graphical objects corresponding to the plurality of functions and while a first respective graphical object from the plurality of graphical objects has input focus, detecting, via the rotatable input mechanism, an input that includes rotation of the rotatable input mechanism; and
in response to detecting the input that includes rotation of the rotatable input mechanism, selecting a second respective graphical object from the plurality of graphical objects that is different from the first respective graphical object.

13. The computer system of claim 12, the one or more programs further including instructions for:
while displaying the plurality of graphical objects corresponding to the plurality of functions, detecting, via the rotatable input mechanism, a press input; and
in response to detecting the press input, ceasing displaying the user interface for selecting a different function to be associated with the first input device without associating a respective function corresponding to a currently selected graphical object from the plurality of graphical objects with the first input device.

14. The computer system of claim 10, wherein displaying the plurality of graphical objects corresponding to the plurality of functions includes displaying a focus indicator corresponding to a graphical object from the plurality of graphical objects that currently has input focus, the one or more programs further including instructions for:
detecting, via the one or more input devices, an input for moving the focus indicator:
in response to detecting the input for moving the focus indicator:
while moving the focus indicator from the graphical object that currently has input focus to a different graphical object, changing, via the one or more display generation components, an appearance of the focus indicator.

15. The computer system of claim 10, wherein displaying the plurality of graphical objects corresponding to the plurality of functions includes:
displaying, via the one or more display generation components, a focus indicator corresponding to a graphical object from the plurality of graphical objects that currently has input focus; and
changing, via the one or more display generation components, an appearance of the focus indicator while moving the focus indicator.

16. The computer system of claim 10, wherein displaying the plurality of graphical objects corresponding to the plurality of functions includes displaying a focus indicator corresponding to a graphical object from the plurality of graphical objects that currently has input focus, wherein the focus indicator visually pulses.

17. The computer system of claim 10, the one or more programs further including instructions for:
while displaying the plurality of graphical objects corresponding to the plurality of functions, detecting, via the one or more input devices, an input that includes activation of the first input device; and
in response to detecting the input that includes activation of the first input device, associating with the first input device a respective function corresponding to a graphical object that currently has input focus from the plurality of graphical objects corresponding to the plurality of functions.

18. The computer system of claim 10, the one or more programs further including instructions for:
while displaying the plurality of graphical objects corresponding to the plurality of functions, detecting, via the one or more input devices, an activation input that includes activation of the first input device; and
in response to detecting the activation input that includes activation of the first input device:
in accordance with a determination that a duration of the activation input is less than a predetermined time threshold, associating with the first input device a respective function corresponding to a graphical object from the plurality of graphical objects that currently has input focus; and
in accordance with a determination that the duration of the activation input is greater than the predetermined time threshold, initiating a process for performing a system function.

19. The computer system of claim 10, the one or more programs further including instructions for:
while displaying the plurality of graphical objects corresponding to the plurality of functions, detecting, via the one or more input devices, a confirmation input; and
in response to detecting the confirmation input:
associating with the first input device a respective function corresponding to a respective graphical object from the plurality of graphical objects corresponding to the plurality of functions, wherein the respective graphical object currently has input focus; and
displaying, via the one or more display generation components, a visual feedback element that provides visual feedback to a user that the respective function corresponding to the respective graphical object has been associated with the first input device.

20. The computer system of claim 19, wherein displaying the visual feedback element includes distorting a portion of a displayed user interface.

21. The computer system of claim 10, wherein the one or more input devices includes a rotatable input mechanism, the one or more programs further including instructions for:
while displaying the plurality of graphical objects corresponding to the plurality of functions, detecting, via the one or more input devices, a selection input; and
in response to detecting the selection input:
in accordance with a determination that the selection input includes activation of the first input device of the one or more input devices:
associating with the first input device a respective function corresponding to a respective graphical object from the plurality of graphical objects, wherein the respective graphical object currently has input focus; and
displaying, via the one or more display generation components, a first visual effect; and
in accordance with a determination that the selection input includes a press input of the rotatable input mechanism:
displaying, via the one or more display generation components, a second visual effect that is different from the first visual effect without associating the respective function corresponding to the respective graphical object with the first input device.

22. A non-transitory computer-readable storage medium storing one or more programs configured to be executed by one or more processors of a computer system that is in communication with one or more display generation components and one or more input devices, the one or more programs including instructions for:
detecting, via the one or more input devices, an activation event that includes activation of a first input device of the one or more input devices; and
in response to detecting the activation event:
in accordance with a determination that the activation event ends within a first period of time and the first input device is associated with a first function, wherein the first period of time ends before a first time threshold has elapsed, initiating a process for performing the first function; and
in accordance with a determination that the activation event ends within a second period of time, wherein the second period of time starts after the first time threshold has elapsed, and wherein the second period of time is different from the first period of time, displaying, via the one or more display generation components, a user interface for selecting a different function to be associated with the first input device.

23. A method, comprising:
at a computer system that is in communication with one or more display generation components and one or more input devices:
detecting, via the one or more input devices, an activation event that includes activation of a first input device of the one or more input devices; and
in response to detecting the activation event:
in accordance with a determination that the activation event ends within a first period of time and the first input device is associated with a first function, wherein the first period of time ends before a first time threshold has elapsed, initiating a process for performing the first function; and
in accordance with a determination that the activation event ends within a second period of time, wherein the second period of time starts after the first time threshold has elapsed, and wherein the second period of time is different from the first period of time, displaying, via the one or more display generation components, a user interface for selecting a different function to be associated with the first input device.
